(19) United States
(12) Patent Application Publication
(10) Pub. No.: US 2025/0060292 A1
(43) Pub. Date: Feb. 20, 2025

(54) MATRICES AND SYSTEMS FOR PRESERVATION OF BIOMOLECULES IN VACUUM

(71) Applicant: WISCONSIN ALUMNI RESEARCH FOUNDATION, Madison, WI (US)

(72) Inventors: Joshua Jacques COON, Middleton, WI (US); Michael Scott WESTPHALL, Fitchburg, WI (US); Kenneth LEE, Madison, WI (US); Austin SALOME, Madison, WI (US); Timothy GRANT, Middleton, WI (US); Jean LODGE, Indianapolis, IN (US)

(73) Assignee: WISCONSIN ALUMNI RESEARCH FOUNDATION, Madison, WI (US)

(21) Appl. No.: 18/694,831

(22) PCT Filed: Sep. 23, 2022
(86) PCT No.: PCT/US2022/044560

§ 371 Date: Mar. 22, 2024

Related U.S. Application Data
(60) Provisional application No. 63/247,705, filed on Sep. 23, 2021.
(60) Provisional application No. 63/331,537, filed on Apr. 15, 2022.
(60) Provisional application No. 63/348,878, filed on Jun. 3, 2022.

(51) Int. Cl. G01N 1/36; G01N 1/28

(52) U.S. Cl. CPC G01N 1/36; G01N 1/2813

(57) ABSTRACT

Methods for preparing imaging samples by applying a liquid or semiliquid substance to a substrate surface in order to mitigate the deleterious effects of vacuum and other conditions used for sample preparation, thereby preserving the structure of at least a portion of deposited samples. These methods are useful for MS-based electron microscopy (EM) sample preparation at room temperature, but are also applicable to other imaging methods. These methods also enable transmission electron microscopy (TEM) structural confirmation of ions passing through a mass spectrometer. Additionally, only entry-level negative staining techniques for TEM are required, making this technique much more widely available than cryogenic electron microscopy (cryo-EM).

### CROSS-REFERENCE TO RELATED APPLICATIONS

This application claims priority from U.S. Provisional Patent Application No. 63/247,705, filed Sep. 23, 2021, U.S. Provisional Patent Application No. 63/331,537, filed Apr. 15, 2022, and U.S. Provisional Patent Application No. 63/348,878, filed Jun. 3, 2022, which are incorporated by reference herein to the extent that there is no inconsistency with the present disclosure

### STATEMENT REGARDING FEDERALLY SPONSORED RESEARCH

This invention was made with government support under GM118110 awarded by the National Institutes of Health. The government has certain rights in the invention.

### BACKGROUND OF THE INVENTION

Mass spectrometry is currently used to analyze the abundances, modification states, interaction partners, and even biochemical pathways in which proteins and other biomolecules function. The use of mass spectrometry has also been investigated as a possible tool for the preparation of biological samples for electron microscopy (EM) and other imaging methods. This is partially due to the fact that native mass spectrometry is able to ionize molecule complexes under conditions that frequently preserve biomolecule structure.

However, exposure of biomolecules to vacuum environments is necessary for electron microscopy-based imaging as well as in many other types of imaging methods. Unfortunately, when biomolecules, particularly proteins or protein complexes, are deposited under vacuum conditions, the tertiary and secondary structure of the biomolecule is often destroyed due to lack of hydration and due to interactions of the biomolecule with the sample surface used for the imaging process.

Using mass spectrometry or other ionizing methods to prepare samples for EM imaging, including but not limited to transmission electron microscopy (TEM) and cryogenic electron microscopy (cryo-EM), typically requires the biomolecules be ionized, admitted to a vacuum chamber, and deposited onto an EM grid or similar surface for eventual imaging. For example, to prepare for EM imaging the sample can be removed from vacuum at room temperature and stained with a heavy metal, such as in negative stain TEM, a technique that is often used for rapidly screening samples but typically offers limited structural resolution. Alternatively, another approach is to freeze and then image the sample directly under low electron dose conditions, such as in cryo-EM. Cryo-EM offers much higher resolving power but requires low temperatures and specimens that do not contain crystalline ice.

In either case, if mass spectrometry is used as an upstream biomolecule sorting device, the biomolecules are deposited onto a TEM grid under vacuum. TEM grids come in many varieties but typically have a thin layer, often graphene, upon which the specimens are deposited. Biomolecules landing on these graphene surfaces are largely desolvated when they reach the surface. In addition to being under vacuum and desolvated, these biomolecules also have interactions with the TEM grid surface and over time (i.e., seconds to minutes) can begin to unfold and melt onto the surface. Such behavior causes loss of the very structure that is the object of the intended preparation and eventual TEM imaging.

Accordingly, what is needed is a way to deposit particles, especially ionized particles such as those generated by mass spectrometry devices, onto TEM grids and other surfaces under vacuum while maintaining the structural integrity of the particles.

### SUMMARY OF THE INVENTION

The present invention provides matrices, devices, and methods of applying such matrices to TEM grids and other surfaces in order to mitigate the deleterious effects of vacuum and other conditions used for sample preparation, thereby preserving the structure of at least a portion of deposited samples and allowing for structural analysis. In particular, the invention provides improved methods for preparing biological samples for structural analysis by electron microscopy (EM) and other imaging systems, with a focus on maintaining protein and other biomolecule structure under challenging conditions and constraints, such as the use of ionization, vacuum or near vacuum conditions, a wide range of temperatures, and interactions with sample grids and surfaces.

In an embodiment, the present invention provides a method for preparing a sample comprising the steps of: a) contacting a substrate surface with a liquid or semiliquid substance thereby forming a matrix layer of the liquid or semiliquid substance on the substrate surface; and b) depositing target molecules having an initial structure onto or within the matrix layer under vacuum, wherein the target molecules are partially embedded in the matrix layer and wherein the initial structure of at least a portion of the target molecules is maintained while within the vacuum.

Target molecules useful with the present invention include, but are not limited to, protein molecules, peptides, glycans, metabolites, drugs, and complexes thereof, multi-protein complexes, protein/nucleic acid complexes, nucleic acid molecules, virus particles, micro-organisms, sub-cellular components (e.g., mitochondria, nucleus, Golgi, etc.), and whole cells. The target molecules are preferably biomolecules, including but not limited to peptides and proteins having secondary, tertiary, and/or quaternary structures, or ions generated from such biomolecules. In an embodiment, the target molecules are proteins having intact secondary and tertiary structure.

In further embodiment, the target molecules are ions generated by ionizing precursor molecules, such as by a mass spectrometer device using electrospray ionization or laser desorption. Optionally, the target molecules are deposited onto or within the matrix layer using a controllable ion beam directed to contact the matrix layer.

As used herein, the term “semiliquid” refers to substances having properties between a solid and a liquid, including but not limited to viscous liquids and sols. In a further embodiment, the liquid or semiliquid is a substance that is a liquid at room temperature. In an embodiment, the liquid or semiliquid forming the matrix layer has a viscosity of at least 800 cP at 20° C., 1000 cP at 20° C., at least 1200 cP at 20° C., or at least 1500 cP at 20° C. In an embodiment, the liquid or semiliquid forming the matrix layer has a boiling point of at least 80° C., at least 100° C., at least 150° C., at least 200° C., or at least 240° C. Suitable liquids and semiliquids for use in the present invention include, but are not limited to glycerol, water, ethylene glycol, poly(ethylene) glycol (PEG), poly(propylene) glycol (PPG), triethanolamine (TEA), TritonX-100, diglycerol, glycose, sucrose, inositol, glycine, proline, trehalose, and combinations thereof. The liquids and semiliquids may contain a mixture of liquids and/or additional components. For example, in an embodiment the liquid comprises a mixture of glycerol with methanol or ethanol. Preferably, the liquid or semiliquid forming the matrix layer is an electrical insulator and prevents electrical interaction between the substrate and the target molecules.

As used herein, the term, “matrix” refers to the components of a sample other than the analyte of interest. Preferably, the matrix layer does not interfere with the structural imaging of the deposited target molecules. Optionally, the matrix layer should have a thickness great enough so that the deposited target molecules are embedded within the matrix layer without being completely covered. In an embodiment, the matrix layer has a thickness between 1 and 100 nm, between 2 and 50 nm, between 5 and 25 nm, or between 10 and 20 nm.

As used in embodiments described herein, “vacuum” refers to a pressure of 10⁻⁴ Torr or less, a pressure 10⁻⁵ Torr or less, or a pressure 10⁻⁶ Torr or less. In certain embodiments, the target molecules are deposited on or within the matrix layer at a pressure equal to or less than 10⁻⁴ Torr, 10⁻⁵ Torr, or 10⁻⁶ Torr.

Preferably, the step of depositing the target molecules on or within the matrix layer is performed a temperature between −90° C. and 50° C., between 0° C. and 40° C., or between 10° C. and 25° C. Optionally, depositing the target molecules is performed at room temperature.

In an embodiment, the target molecules are deposited onto or within the matrix layer using an analyte beam. Preferably, the analyte beam is an ion beam. In certain embodiments, the analyte beam is characterized by an intensity selected from the range of 0.025 to 25 particles per 1 μm² per second, 0.05 to 10 particles per 1 μm² per second, or 0.1 to 5 particles per 1 μm² per second. In certain embodiments, the analyte beam is characterized by a spot size selected from the range of 400 μm² to 4.0E7 μm², from the range of 800 μm² to 3.8E7 μm², or from the range of 1,000 μm² to 1,500 μm².

Optionally, the substrate described in the embodiments provided herein is an electron microscopy (EM) grid as known in the art. The EM grid may comprise a metal, including but not limited to copper, rhodium, nickel, molybdenum, titanium, stainless steel, aluminum, gold, or combinations thereof as known in the art. Additionally, the EM grid may comprise a continuous film or membrane which is positioned across the top or bottom surface of the grid, or within the holes of the grid, so as to provide a solid support for the formation of the matrix layer. Preferably, the EM grid is covered by a thin film or membrane which includes, but is not limited to, films and membranes comprising graphene, graphene oxide, silicon oxide, silicon nitride, carbon, and combinations thereof. In an embodiment, the substrate is an EM grid comprising a graphene or graphene oxide monolayer film or membrane positioned across the surface of the grid.

The structures of the partially embedded target molecules are able to be imaged using imaging techniques as known in the art, including but not limited to transmission electron microscopy (TEM), scanning electron microscopy (SEM), cryogenic electron microscopy (cryo-EM), X-ray imaging, fluorescent labeling, immunolabeling, and combinations thereof. In an embodiment, the method further comprises generating three-dimensional reconstructed images of the target molecules from the imaging results.

In certain embodiments described herein, once the target molecules are deposited on the matrix layer, a staining step is performed so as to facilitate imaging of the deposited target molecules. In an embodiment, the staining step comprises contacting exposed areas of the partially embedded target molecules with metal particles or a metal containing solution. Optionally, the staining step comprises negative staining or rotary shadowing. In an alternative embodiment, the deposited target molecules are reacted so that a portion of the partially embedded target molecules contain a fluorescent tag, epitope tag or antibody tag that are used to detect or analyze the structure or specific portions of the structure of the tagged molecule.

Preferably, the present invention is directed to mass spectrometry (MS)-based systems for preparing samples for EM imaging, including but not limited to TEM and cryo-EM, as well as other imaging methods. In an embodiment, a thin layer of a viscous liquid such as glycerol or poly(propylene) glycol (PPG) is applied to a graphene surface of a TEM grid prior to depositing biomolecules onto the surface, thereby preserving the structure of the biomolecules.

In an embodiment, the present invention provides a system for depositing target molecules on a substrate comprising: a) an ion source able to generate ions from a sample of molecules; b) first ion focusing optics in fluid communication with the ion source; c) ion separation optics in fluid communication with the first ion focusing optics, wherein the first ion focusing optics are able to transport ions from the ion source to the ion separation optics, and wherein the ion separation optics are able to separate ions according to the mass-to-charge ratios of the ions; d) a sample chamber in fluid communication with the ion separation optics, wherein the sample chamber contains a substrate able to be removed from the sample chamber. The sample chamber is able to be maintained at a vacuum during operation. Furthermore, the substrate is able to be inserted into and removed from the sample chamber while maintaining the vacuum.

Preferably, the sample chamber has an interior pressure equal to or less than 10⁻⁴ Torr, 10⁻⁵ Torr, or 10⁻⁶ Torr. Additionally, the sample chamber preferably is able to provide an interior temperature between −90° C. and 50° C., between 0° C. and 40° C., or between 10° C. and 25° C. In an embodiment, the substrate is an electron microscopy (EM) grid.

In an embodiment, the system further comprises a controller, operably connected to the first ion focusing optics, the ion separation optics, and the sample chamber, where the controller controls the first ion focusing optics and ion separation optics so as to: transport the ions from the ion source to the ion separation optics; generate a first distribution of precursor ions from the transported ions; isolate a target range of mass-to-charge ratios within the first distribution of precursor ions, thereby generating separated ions; generate an ion beam comprising the separated ions; and contacting the substrate in the sample chamber with the ion beam, thereby depositing separated ions on the substrate under a vacuum. Preferably, a matrix layer of a liquid or semiliquid substance is deposited on the substrate prior to inserting the substrate into the sample chamber and prior to depositing the ions onto the substrate.

In an embodiment, the system further comprises a mass analyzer in fluid communication with the ion separation optics able to detect the separated ions. The controller is able to controller the mass analyzer so as to measure the mass-to-charge ratios of the separated ions and generate mass spectrometry data. Additionally, the system optionally comprises second ion focusing optics in fluid communication with the ion separation optics, the mass analyzer, and sample chamber, and under operational control of the controller so as to be able to transport the separated ions from the ion separation optics to the mass analyzer and/or the sample chamber.

As used throughout the present description, the term “ion optics” is intended to be inclusive of ion optic components of a mass spectrometer system, including, for example, one or more ion guides, ion focusing optics, ion separation optics and combinations thereof. As used throughout the present description, the term “mass analyzer” is intended to be inclusive of detector components of a mass spectrometer system, including, for example, one or more ion detectors.

In an embodiment, the present invention provides a method for preparing a sample for electron microscopy (EM) comprising the steps of: a) contacting a substrate surface with a liquid or semiliquid substance thereby forming a matrix layer of the liquid or semiliquid substance on the substrate surface, wherein the substrate is an electron microscopy (EM) grid; b) generating a first distribution of precursor ions from a sample of target molecules; c) separating a portion of ions from the first distribution of precursor ions according to mass-to-charge ratios of the precursor ions, thereby generating separated ions; d) generating an ion beam containing the separated ions, and e) directing the ion beam to the substrate surface under vacuum; thereby depositing target molecule ions onto or within the matrix layer, wherein the target molecule ions are partially embedded in the matrix layer and wherein the structure of at least a portion of the target molecule ions is retained. Optionally, the substrate surface containing the deposited target molecule ions is directly transferred to a microscope portion of a cryo-electron or transmission electron microscope.

Certain aspects of the invention further include the use of mass spectrometry to purify target molecule ions, including but not limited to desired proteins, protein complexes, and other biomolecules, in the gas-phase for subsequent imaging. One implementation of this method utilizes a modified mass spectrometer that allows for gas-phase purification of target molecule ions. In an embodiment, the step of generating a first distribution of precursor ions and the separating step are performed by a modified mass spectrometer.

In an embodiment, the target molecule ions are purified or isolated, such as by a mass spectrometer device, before being deposited onto the matrix layer. Preferably, the target molecule ions are characterized by a purity of at least 50%, 60%, 75%, 85%, 90%, 95%, or 99%. For target molecules, such as proteins, which may have significant conformational structures, it is desirable that the target molecules are characterized by a conformation purity of at least 50%, 60%, 75%, 85%, 90%, 95% or 99%. For example, it may be desirable to analyze the structure of a particular protein as expressed in a cell. Accordingly, it is necessary to provide an EM sample where all or most of the protein target molecules retain the same conformational structure.

In certain embodiments, the substrate is exposed to the ion beam for a time between 10 to 1,000 seconds, for a time between 30 to 800 seconds, for a time between 60 to 600 seconds, for a time between 30 to 300 seconds, or for a time between 60 to 300 seconds.

### BRIEF DESCRIPTION OF THE DRAWINGS

FIG. 1 and FIG. 2 show GroEL particles deposited under vacuum onto a graphene covered TEM grid using a mass spectrometer, where the TEM grid does not contain a matrix layer on the surface. After landing, the particles were removed from vacuum, negative stained, and imaged using TEM. The various blobs and spots are GroEL particles of the approximate size; however, the particles appear to have lost the characteristic features of their structure.

FIG. 3 and FIG. 4 show GroEL particles deposited under vacuum onto a graphene covered TEM grid using a mass spectrometer, where a thin glycerol layer has been added to the surface of the TEM grid. After landing, the particles were similarly removed from vacuum, negative stained, and imaged using TEM. In these examples, the characteristic structures of the GroEL particles can be seen.

FIG. 5 shows mass spectrometry spectra and negative stain TEM images of three exemplary proteins, GroEL, alcohol oxidase, and beta galactosidase. Panels A, E and I show native mass spectra of GroEL complexes, alcohol oxidase complexes, and β-galactosidase complexes, respectively, along with molecular model images. Panels B, F and J show negative stain TEM images of GroEL ions, alcohol oxidase ions, and β-galactosidase ions, respectively, landed onto bare carbon TEM grids (no matrix layer present) under vacuum. Panels C, G and K show negative stain TEM images of GroEL ions, alcohol oxidase ions, and β-galactosidase ions, respectively, landed onto TEM grids coated with a thin film of glycerol—i.e., matrix-landed. Panels D, H and L show negative stain TEM images of GroEL molecules, alcohol oxidase molecules, and β-galactosidase molecules, respectively, that were conventionally prepared using a pipette (no vacuum). Note the structural models contained in panels A, E, and I were generated from PDB structures (PDB:5W0S, PDB:6H3G, PDB:6X1Q) and included here to aid in image interpretation.^{27, 30, 31}

FIG. 6 shows a 3D reconstruction of GroEL complexes that were matrix-landed from the ion beam of a modified Orbitrap mass spectrometer. Panel A shows 2D Class averages obtained from negatively-stained matrix-landed GroEL cations. Panel B shows top and bottom views of a three-dimensional reconstruction of GroEL made from the particles contained within the class averages shown in panel A. Panel C illustrates the fit of previously determined GroEL structure (PDB:5W0S) into the reconstruction shown in panel B demonstrating good overall structural agreement.

FIG. 7 shows top and bottom views of a three-dimensional reconstruction of GroEL calculated from images of conventionally prepared negative-stain grids. The images were processed using the same processing procedure as for the matrix-landed reconstruction shown in FIG. 6 and the reconstruction contains approximately the same number of particles.

FIG. 8 illustrates exemplary systems of the present invention for depositing samples on a substrate. Panel A depicts an apparatus where ions are generated from the target molecules and transported to ion separation optics, where the ions are separated and the desired target ions used to form an ion beam. The ion beam is directed to the surface of a substrate, which can be removed from the apparatus. Panel B shows an Orbitrap mass spectrometer modified to conduct matrix-landing of biomolecular ions in an embodiment of the invention. Ions are generated by nano-electrospray and initially injected into the stacked ring ion guide (SRIG). The ions are then moved through the MS system and either injected into the Orbitrap mass analyzer for mass measurement or directed to the TEM grid. The DC offset potentials used during landing experiments is shown on the bottom of the panel.

FIG. 9 shows ion trap ETD ion volume exchange components converted for TEM grid insertion into Ultra-High Mass Range (UHMR) mass spectrometer in an embodiment. Panel A shows incorporation of the inlet valve and guide bar assembly required a new endplate for the vacuum chamber of UHMR to be fabricated. The atmospheric side (left) and vacuum side (right) of the cover are displayed. Panel B shows mechanical drawings required to duplicate the endplate. Dimensions are displayed in units of millimeters.

FIG. 10 shows negative stain TEM images of GroEL with and without vacuum exposure. Panel A shows GroEL particles that were pipetted onto a bare TEM grid and immediately stained and imaged. Panel B shows the same particles that were placed under vacuum (comparable to the landing apparatus pressures) for a period of 10 minutes prior to staining. GroEL particles are damaged following just 10 minutes of vacuum exposure. These images produce results strikingly similar to those of landed GroEL particles on bare TEM grids. Panel C shows the same experiment except for (1) the TEM grid was treated with a thin film of glycerol and (2) the sample was exposed to vacuum for 60 minutes. Even after this extended vacuum exposure, intact GroEL particles were clearly visible. The images shown here were acquired from no fewer than five samples each.

FIG. 11 shows 3D reconstruction of GroEL complexes that were either matrix-landed from the ion beam of a modified Orbitrap mass spectrometer or conventionally prepared. Panel A shows 2D class averages obtained from negatively-stained matrix-landed GroEL cations. Panel B shows Top and bottom views of a three-dimensional reconstruction of GroEL made from the particles contained within the class averages shown in Panel A, fit to a previously determined GroEL structure (PDB:5W0S). Panel C shows top and bottom views of the images of panel B without ribbon model. Panel D shows top and bottom views of conventionally prepared and imaged GroEL. Panel E shows difference maps of matrix-landed and conventionally prepared GroEL. Top structure in panel E presents the subtraction of the conventionally prepared model from the landed model (where darker shading indicates difference) while the bottom displays the reverse (lighter shading indicating a difference).

FIG. 12 shows single subunit density maps of GroEL from either matrix-landing (left) or conventional samples (right). Panel A shows the fit of a single subunit PDB reference ribbon structure to the overall models obtained by either method. Note the exposed helices in both models that are not contained within the calculated model density. These data confirm that the matrix-landing sample is no different than the result obtained by conventional negative staining TEM. Panel B shows an exploded view of single GroEL subunit. Note: ribbon structure from PDB:5W0S.

FIG. 13 shows a flow chart of negative stain image processing for landed Gro-EL. A representative raw stain image and 2D class averages are shown. Automatic particle picking resulted in ˜15,000 picked particles. After 2D classification and selection of the best classes ˜7,000 particles were kept. Ab-inito 3D reconstruction followed by auto-refinement and map sharpening resulted in the final 3D reconstruction which is shown along with a plot demonstrating the angular distribution of the particles.

FIG. 14 shows chemical matrices that allow for protein complex preservation from vacuum exposure on TEM grids. Panels A-G show negative stain TEM images of GroEL that were mixed with each matrix, pipetted onto the TEM grid, and then conventionally stained. Panels H-N show negative stain TEM images of GroEL that were mixed with each matrix, pipetted onto the TEM grid, exposed to vacuum, and then conventionally stained. Panels O-U show negative stain TEM images of pretreated grids with each matrix followed by the addition of GroEL onto the grid, exposed to vacuum, and then conventionally stained.

FIG. 15 shows a modified Orbitrap mass spectrometer and comparison of matrices for the soft-landing of GroEL. Panel A shows a diagram of a modified UHMR mass spectrometer and cartoon of soft-landing GroEL particles. Panel B shows negative stain image of GroEL ions soft-landed onto a thin film of PPG. Panel C shows negative stain image of GroEL ions soft-landed onto a thin film of TritonX-100. Panel D shows negative stain image of GroEL ions soft-landed onto a thin film of diglycerol.

FIG. 16 shows the structural integrity of GroEL after ionization, transit through the mass spectrometer, and landing in a matrix of PPG. Panel A shows a mass spectrum of GroEL and estimated mass. Panel B shows negative stain TEM grid of pipetted GroEL. Panel C shows negative stain TEM grid of soft-landed ions preserved in a thin layer of PPG. Panel D shows 2D class averages from soft-landed GroEL ions. Panel E shows a 3D overlay of GroEL crystal structure with soft-landed reconstructed model. Panel F shows a soft-landed reconstructed model of GroEL. Panel G shows conventionally pipetted and negatively stained 3D reconstruction model of GroEL.

FIG. 17 shows negative stain TEM grids with and without rinsing of grid with buffer prior to staining. Panel A shows negative stain TEM image of soft-landed GroEL ions into PPG without rinsing the grid with 1M ammonium acetate before staining. Panel B shows negative stain TEM image of soft-landed GroEL ions into PPG rinsed with 1M ammonium acetate prior to staining. Panel C shows negative stain TEM image of soft-landed 20S Proteasome ions into PPG without rinsing the grid with 1M ammonium acetate before staining. Panel D shows negative stain TEM image of soft-landed 20S Proteasome ions into PPG rinsed with 1M ammonium acetate prior to staining. Panel E shows negative stain TEM image of soft-landed β-Galactosidase ions into PPG without rinsing the grid with 1M ammonium acetate before staining. Panel F shows negative stain TEM image of soft-landed β-Galactosidase ions into PPG rinsed with 1M ammonium acetate prior to staining.

### DETAILED DESCRIPTION OF THE INVENTION

### Definitions

As used herein, the term “ion source” refers to a device component which produces ions from a sample. Examples of ion sources include, but are not limited to, electrospray ionization sources and matrix assisted laser desorption/ionization (MALDI) sources.

As used herein, the term “ion optic” refers to a device component which assists in the transport and manipulation of charged particles, for example ions, by the application of electric and/or magnetic fields. The electric or magnetic field can be static, alternating, or can contain both static and alternating components. Ion optical device components include, but are not limited to, ion deflectors which deflect ions, ion focusing optics and lenses which focus ions, and multipoles and flatapoles (such as quadruples) which confine ions to a specific space or trajectory. Ion optics include multipole RF device components which comprise multiple rods having both static and alternating electric and/or magnetic fields.

As used herein, the term “controller” refers to a device component which can be programmed to control a device or system, as is well known in the art. Controllers can, for example, be programmed to control mass spectrometer systems as described herein. Controllers can be programmed, for example, to carry out ion manipulation and sample analysis methods as described herein on systems and devices as described herein.

As used herein, the term “mass spectrometer” refers to a device which creates ions from a sample, separates the ions according to mass, and detects the mass and abundance of the ions. Mass spectrometers include multistage mass spectrometers which fragment the mass-separated ions and separate the product ions by mass one or more times. Multistage mass spectrometers include tandem mass spectrometers which fragment the mass-separated ions and separate the product ions by mass.

As used herein, the term “precursor ion” is used herein to refer to an ion which is produced during ionization by a mass spectrometer device analysis, such as during MS1 ionization during MS analysis.

As used herein, the term “mass-to-charge ratio” refers to the ratio of the mass of a species to the charge state of a species. The term “m/z unit” refers to a measure of the mass to charge ratio. The Thomson unit (abbreviated as Th) is an example of an m/z unit and is defined as the absolute value of the ratio of the mass of an ion (in Daltons) to the charge of the ion (with respect to the elemental charge).

The terms “peptide” and “polypeptide” are used synonymously in the present disclosure, and refer to a class of compounds composed of amino acid residues chemically bonded together by amide bonds (or peptide bonds). Peptides are polymeric compounds comprising at least two amino acid residues or modified amino acid residues. Peptides include compositions comprising a few amino acids and include compositions comprising intact proteins or modified proteins. Modifications can be naturally occurring or non-naturally occurring, such as modifications generated by chemical synthesis. Modifications to amino acids in polypeptides include, but are not limited to, phosphorylation, glycosylation, lipidation, prenylation, sulfonation, hydroxylation, acetylation, methionine oxidation, alkylation, acylation, carbamylation, iodination and the addition of cofactors. Peptides include proteins and further include compositions generated by degradation of proteins, for example by proteolytic digestion. Peptides and polypeptides may be generated by substantially complete digestion or by partial digestion of proteins. Identifying or sequencing a peptide refers to determination of is composition, particularly its amino acid sequence, and characterization of any modifications of one or more amino acids comprising the peptide or polypeptide.

“Protein” refers to a class of compounds comprising one or more polypeptide chains and/or modified polypeptide chains. Proteins may be modified by naturally occurring processes such as post-translational modifications or co-translational modifications. Exemplary post-translational modifications or co-translational modifications include, but are not limited to, phosphorylation, glycosylation, lipidation, prenylation, sulfonation, hydroxylation, acetylation, methionine oxidation, the addition of cofactors, proteolysis, and assembly of proteins into macromolecular complexes. Modification of proteins may also include non-naturally occurring derivatives, analogues and functional mimetics generated by chemical synthesis. Exemplary derivatives include chemical modifications such as alkylation, acylation, carbamylation, iodination or any modification that derivatizes the protein. Proteins of the present invention may be derived from sources, which include but are not limited to cells, cell or tissue lysates, cell culture medium after cell growth, whole organisms or organism lysates or any excreted fluid or solid from a cell or organism. Proteins may be characterized and/or analyzed by their secondary structure, tertiary structure, and quaternary structure. Accordingly, it is beneficial if the protein structure can be maintained during preparation of samples for analysis.

“Native mass spectrometry” refers to the analysis and characterization of macromolecules, predominantly intact proteins and protein complexes, where as much as possible the native structural features of the molecules are retained

### Overview

Given the demands of cryo-EM (e.g., sample preparation time, required conditions, expense of necessary equipment, etc.), researchers commonly use EM techniques able to be performed at room temperature, such as TEM. A commonly used method for TEM is negative staining, which requires removal of the sample from vacuum followed by staining with a heavy metal. Negative staining has several advantages, including rapid preparation time and analysis as well as compatibility with room temperature preparation. However, negative staining suffers from limited structural resolution. As a result, TEM imaging is often supplemented with higher resolution cryo-EM for structural analysis. In either instance, the biomolecules must be landed on a sample grid under vacuum, where the sample grid is generally graphene based or coated with graphene, which introduces opportunities for the sample to lose its characteristic structure.

Accordingly, it is desirable to minimize changes in sample structure by modifying the sample grid and providing a protective material around the deposited samples. Such an improvement could expand the capabilities of MS-based sample preparation system to include negative staining TEM and other imaging systems performed at room temperature.

In one aspect of the invention, a thin layer of a viscous liquid (e.g., glycerol, poly(ethylene) glycol, or poly(propylene) glycol) is deposited on the TEM grid prior to the deposition of the sample. This approach is compatible with MS-based sample preparation, requiring only a relatively simple addition to the TEM grid. The thin layer of viscous liquid preserves the landed biomolecules, protecting them from the negative effects of the vacuum and interactions with the grid surface itself.

Without being bound by theory, it is believed the liquid layer is providing protection to the sample, not just from the vacuum conditions, but also from interactions with the TEM grid itself. This protection could be a direct or indirect interaction with the protective liquid, such as via hydrogen bonding to residual water on the sample to form a “shell”. However, because the protective liquid can evaporate, there are timing constraints in that the landed sample must be negative stained before the liquid fully evaporates. Further, if the liquid layer is too thick, it may not be possible to perform staining. Accordingly, the process should be optimized to arrive at the most advantageous timing, temperature, exposure to vacuum, and amount of sample to be landed. Previous experiments have used mass spectrometry to generate ionized molecules that are deposited into an untreated TEM grid at room temperature for negative staining. However, proteins deposited under these untreated conditions did not retain any identifying structural features.

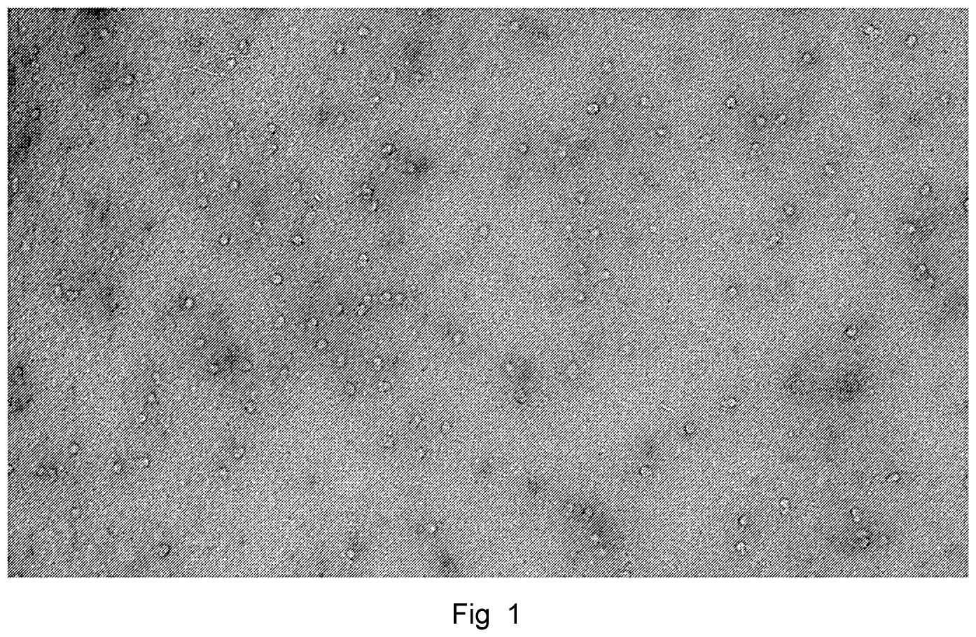

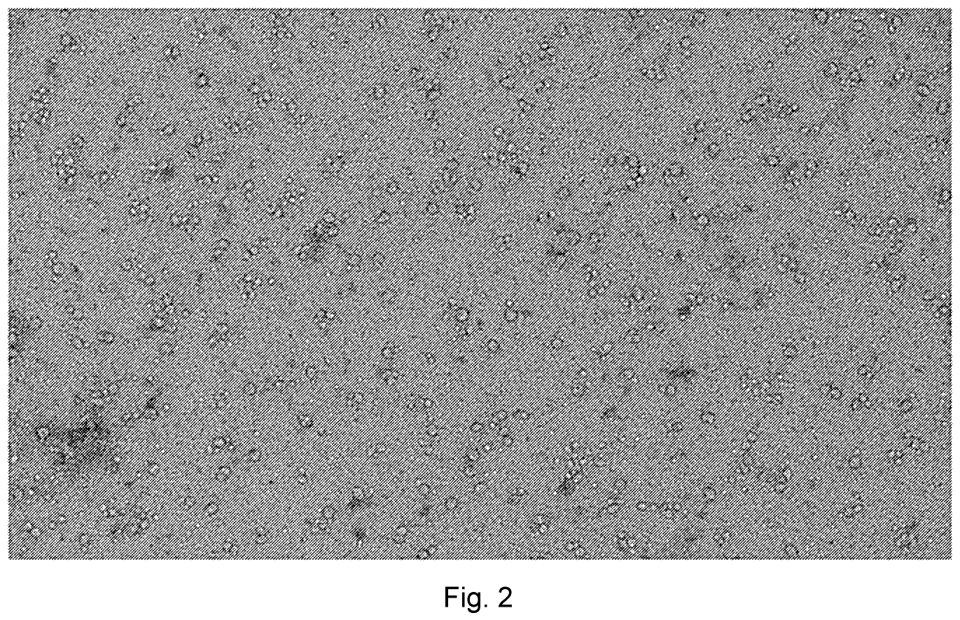

For example, FIGS. 1 and 2 illustrate GroEL particles that were landed onto an untreated graphene covered TEM grid under vacuum using a mass spectrometer for a period of seven minutes. GroEL (chaperonin 60) is a protein from Escherichia coli belonging to the ubiquitous family of heat-shock molecular chaperones found in prokaryotes and in eukaryotic organelles. After landing, the particles were removed from vacuum, negative stained, and imaged using TEM. The various blobs and spots are GroEL particles of the approximate anticipated size; however, the particles appear to have lost the characteristic features of their structure.

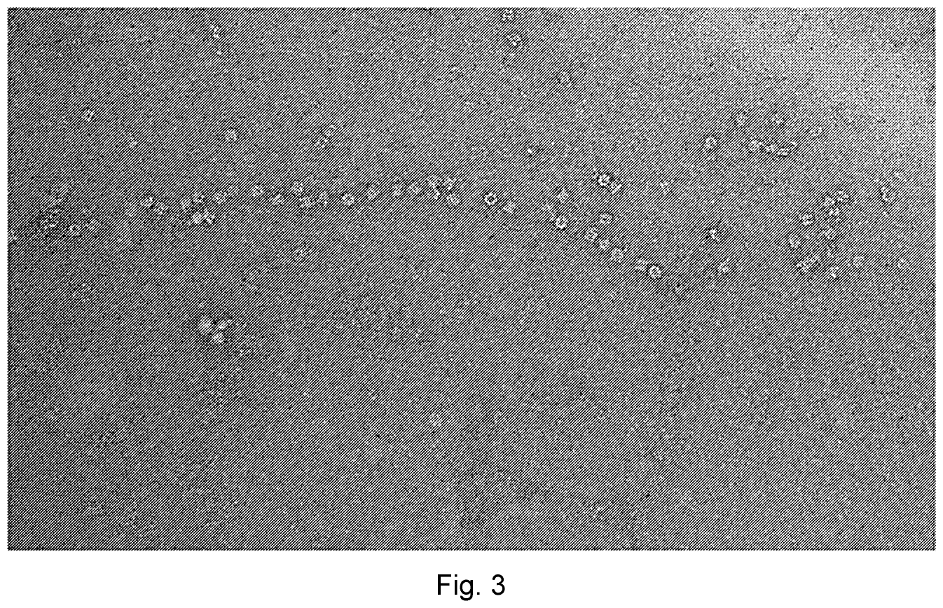

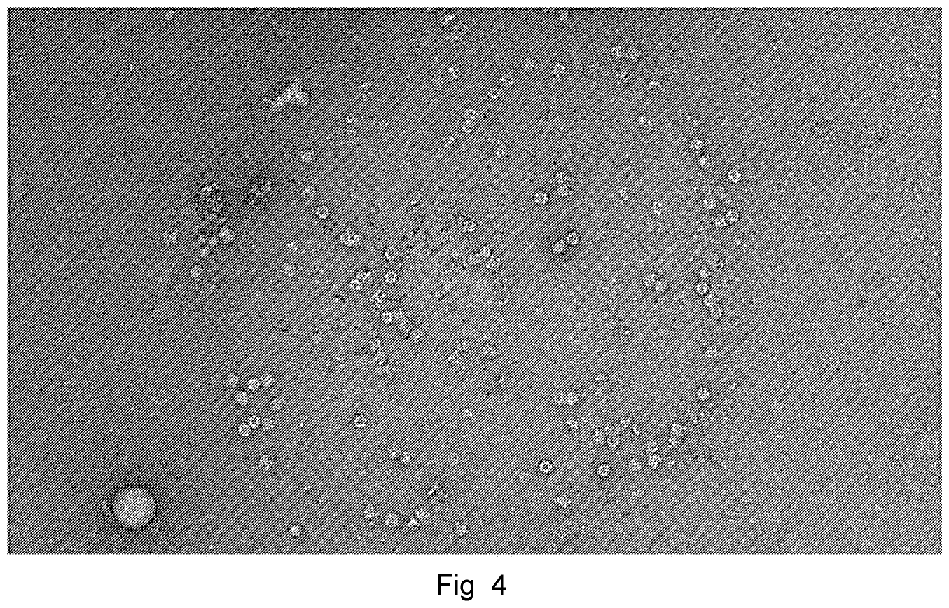

However, using the matrices of the present invention, the biomolecular structure of these protein complexes are able to be preserved. FIGS. 3 and 4 show the resulting images that can be obtained by doing the same experiment as above but with the addition of a thin glycerol layer prior to landing. End views of GroEL are clearly visible and show a seven member donut while side views show four lines indicated the four stacked donuts that makeup GroEL. These data confirm that glycerol provides a preservative effect on the landed biomolecules, protecting them from the negative effects of the vacuum and surface. Other similar molecules should work comparably well including water, ethylene glycol, glycose, sucrose, inositol, glycine, proline, trehalose, among others.

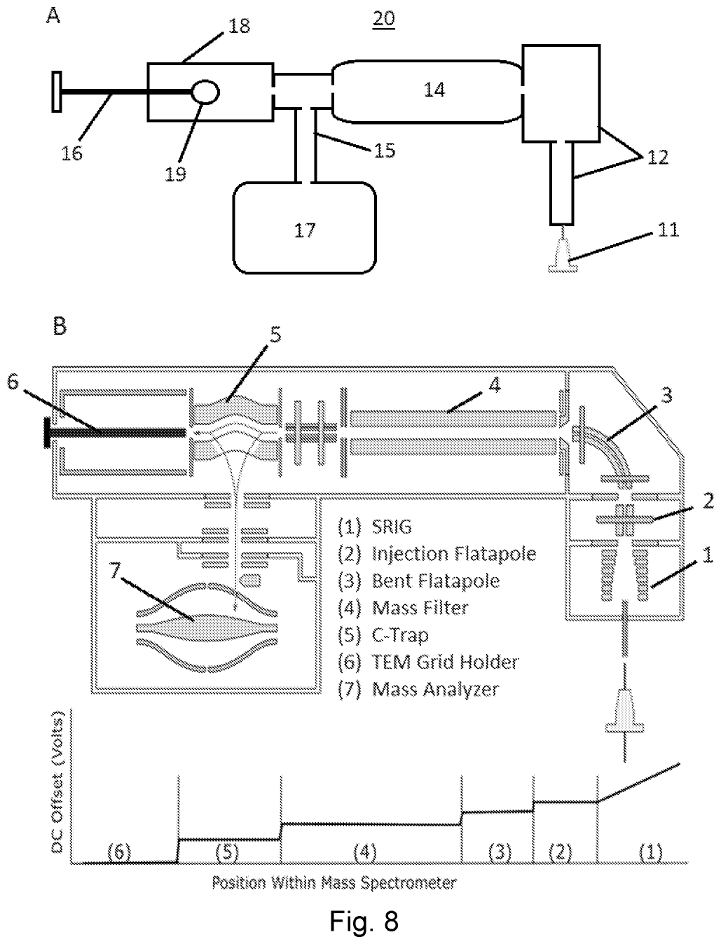

FIG. 8, panel A, illustrates an apparatus 20 used to prepare samples in an embodiment of the invention. Ions are generated from target molecules and transported from an ion source 11 through first ion focusing optics 12 to ion separation optics 14, where the ions are able to be separated and/or purified. The desired separated ions are selected to form an ion beam directed to the surface of a substrate 19 positioned within a sample chamber 18. The substrate 19 is able to be inserted into and removed from the sample chamber 18 using retractable probe 16 while maintaining the vacuum within the sample chamber 18. To prepare a sample, a matrix of the present invention can be deposited onto the substrate and the substrate placed inside the chamber to receive the target ions, after which the substrate is removed and analyzed. Optionally, the apparatus 20 further contains second ion focusing optics able to transport the separated to a mass analyzer 17 which can measure the mass-to-charge ratios of a portion of the ions.

### EXAMPLES

### Example 1—Coupling Mass Spectrometry to Electron Microscopy with Matrix-Landing

Introduction. Native mass spectrometry (MS) is an emerging technology that can provide complementary data to electron microscopy (EM) for protein structure characterization. Beyond the ability to provide mass measurements of gas-phase biomolecular ions, MS instruments offer the ability to purify, select, and precisely control the spatial location of these ions. This example presents a modified Orbitrap MS system capable of depositing a native MS ion beam onto EM grids. Further described is the use of a chemical landing matrix that both preserves and protects the structural integrity of the deposited particles. With this system, the first 3D reconstructed structure of gas-phase, deposited biomolecular ions, the ˜800 KDa protein complex GroEL, was obtained. These data provide direct evidence that non-covalent protein complexes can indeed retain their condensed-phase structures following ionization and vaporization. Developments of this technology can further pave the way to an integrated MS-EM technology able to provide improved cryo-EM sample preparation over conventional plunge-freezing techniques.

Description Electrospray ionization (ESI) coupled with mass spectrometry (MS) has transformed the ability to characterize proteins on a terrific scale.¹ Perhaps no area of protein mass spectrometry better exemplifies this than native mass spectrometry, where entire protein complexes are gently ionized, vaporized, and mass analyzed all while remaining intact.² These mass measurements can provide invaluable information on sub-unit stoichiometry, connectivity, and even the presence of non-covalently bound ligands.

Whether ionized protein complexes truly retain their structure in the gas-phase has been debated for decades.³ Collisional cross-sections of numerous gas-phase protein complexes have been experimentally determined by ion mobility mass spectrometry.⁴⁻⁶ In general, these collective data indicate that under optimal conditions the measured cross-sections are consistent with condensed-phase structures. Seeking a direct measurement, Robinson and co-workers configured a quadrupole time-of-flight (q-ToF) mass spectrometry with a transmission electron microscopy (TEM) grid holder and deposited ions GroEL and ferritin.^{7,8} These studies imaged particles of roughly the correct size and shape via negative and positive staining TEM. The resultant images, however, lacked the higher resolution features typical of a conventional staining experiment. This lack of detail opens the possibility of structural damage occurring during the experiment and prevents solving the 3D structure from the images. More recently, Longchamp et al. imaged soft-landed small proteins using low-energy electron holography followed by numerical reconstruction-again, confirming the ability to soft land onto a surface. However, given the small size of the molecules imaged and lack of details in the reconstructed images it is difficult to tell whether the landed proteins are damaged or not.⁹

Encouraged by the unrealized potential of native mass spectrometry to couple directly with electron microscopy, the present examples explored new configurations and approaches for depositing gas-phase protein complexes onto surfaces for direct EM imaging. First, a quadrupole Orbitrap hybrid system (Ultra-High Mass Range Q-Exactive¹⁰) was modified by removing the collision cell and modifying the end vacuum cap to allow for an insertion probe to hold a TEM grid to the rear of the C-trap exit lens (FIG. 8, panel B). With this modification, the ion beam can either be mass analyzed or directed towards a TEM grid.

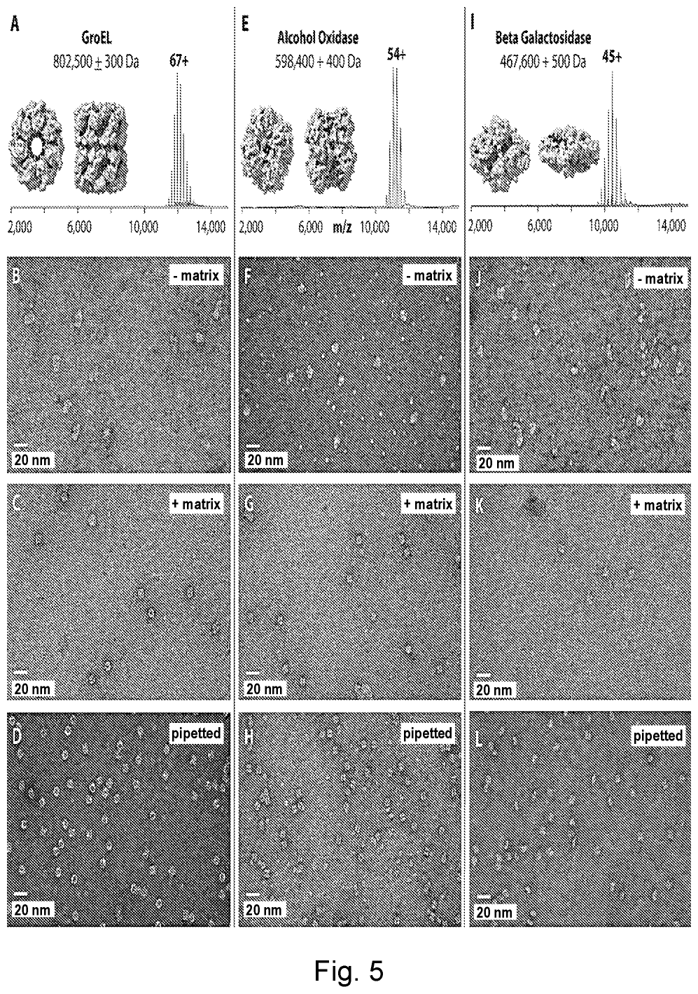

To test the apparatus, the bacterial chaperonin GroEL, an ˜800 kDa homo-oligomer having 14 identical subunits, was analyzed as it has been extremely well-characterized both by native mass spectrometry and microscopy.¹¹ Using nanoESI, charge states were observed ranging from +71 to +62 across the m/z range of 11,000 to 13,000 and having the calculated molecular weight of 802,500 Da+300 Da (FIG. 5, panel A). Next, the GroEL ion beam was deposited onto glow discharged carbon coated TEM grids for durations of 60 to 600 seconds.

After deposition the TEM grids were removed from vacuum, stained with uranyl acetate, and immediately viewed using TEM (FIG. 5, panel B). Particles were observed across much of the TEM grids at reasonably high densities; however, the structural features that define GroEL, i.e., rings and lines, were not observed. Instead, irregular shaped, but mainly featureless particles of approximately the size of GroEL were observed. These images reproduced well those reported by Robinson et al.^{7,8}

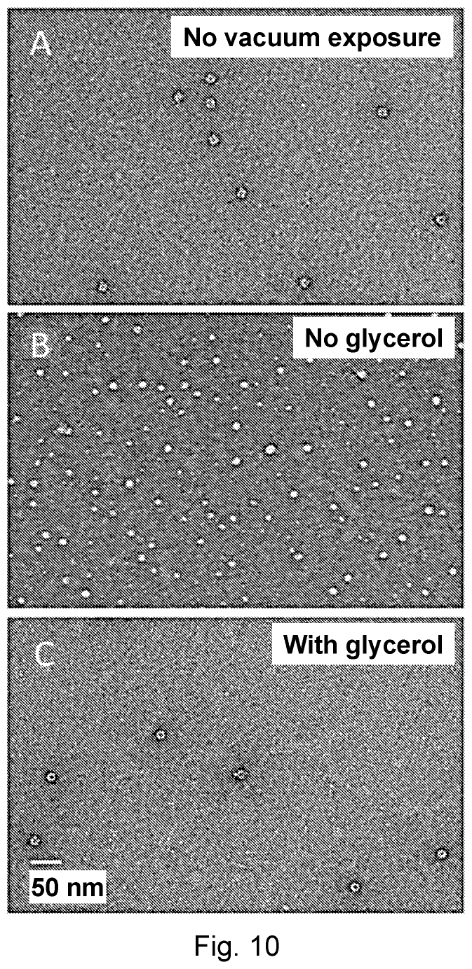

From these data it was supposed that the GroEL ions had lost their condensed-phase structure via: (1) the process of ionization, vaporization, and transport through mass spectrometry, (2) lengthy exposure to high vacuum without solvent (i.e., up to 600 seconds on surface), (3) dissociation upon collision with grid surface during landing, and/or (4) interactions with the TEM grid surface. The most central of these possibilities being the effect of vacuum exposure—about ten minutes for the landing durations used in FIG. 5, panel B. To test the effects of vacuum exposure, GroEL particles were pipetted directly onto a TEM grid, placed the grid in vacuum (15 minutes at 2×10⁻⁵ Torr), followed by staining and TEM imaging. The resultant images (FIG. 10) contained irregular shaped, featureless particles of approximately the size of GroEL, much like those in FIG. 5, panel B. These data reveal that extended exposure to vacuum alone abolishes the overall structural integrity of the GroEL assembly.

To further probe this issue, the TEM grid surface was altered by addition of a chemical matrix. Cryoprotective compounds (e.g., glycerol, trehalose, glucose, ionic liquids, etc.) can promote preservation of protein structure, even when dehydrated and/or in vacuum environments; further, several studies have shown the benefits of direct TEM imaging from sugar-fixed particles.¹²⁻¹⁵ Additionally, two MS studies reported using glycerol-coated deposition surfaces to collect and, ultimately, show biological viability of soft-landed single proteins and intact viruses.^{16,17}

Following these leads, a uniform thin film of glycerol matrix was produced by depositing a small volume (˜3 μL) of glycerol onto the carbon TEM grid surface followed by manual blotting, insertion into the modified Orbitrap, and GroEL cation beam deposition. After a deposition period of up to 600 seconds, the TEM grids were removed and negatively stained. The coated grid was then spotted with GroEL, placed in a vacuum (10-60 minutes, 2×10⁻⁵ Torr), and imaged using negative stain TEM.

The resultant images revealed structurally intact GroEL (FIG. 10) and had no detectable differences than those not exposed to vacuum. Next, grids pretreated with a glycerol matrix were used to perform GroEL landing experiments. Following a deposition period of up to 30 minutes, the TEM grids were removed and negatively stained. With the glycerol matrix present, similar GroEL particle distributions were observed as in the previous landing attempts; however, the particles displayed the characteristic features expected for negatively stained and structurally intact GroEL (FIG. 5, panel C) as observed in the conventionally prepared sample (FIG. 5, panel D). Seven member rings (end views) and the four lines indicating the tetrameric stacked rings (side views) are clearly visible for both the matrix-landed and conventional samples.

To test whether this phenomenon was unique to GroEL, the deposition behavior of two other well-studied protein complexes were explored. The first, alcohol oxidase (AOX, a homo-octamer) 18 was similarly subjected to nano-electrospray and measured at a mass of 598,400±400 Da (FIG. 5, panel E). Deposition of these ions onto the bare TEM grids again resulted in visibly distorted particles of varying size (FIG. 5, panel F). FIG. 5, panel G displays an image of these same cations when deposited onto glycerol-treated TEM grids. As with GroEL, the expected structural features of the AOX complex are preserved in the presence of the matrix (conventionally prepared AOX shown in FIG. 5, panel H). Next, the tetrameric β-galactosidase complex, which comprises four identical 1023 residue long sub-units, was analyzed.¹⁹ The smallest of the three complexes studied here, β-galactosidase weighs in at just under 500 KDa (FIG. 5, panel I). Panels J-K of FIG. 5 illustrate the same trend as observed with GroEL and AOX—the glycerol matrix preserves the landed cationic protein complex.

Following the initial supposition, these data provide strong evidence that either exposure to vacuum and/or interactions with the TEM grid surface are likely the key factors governing the structural preservation of soft-landed particles. At present, it is believed both phenomena are likely at play and, to some extent, are mitigated by the matrix. First, few quality particles are observed following extended vacuum exposures (>30 minutes) of a matrix-landed protein complex following negative staining, underscoring the importance of a high flux ion beam to reduce the time required for sample preparation. Second, because glycerol is a dielectric, it is hypothesized that the matrix serves to prevent neutralization of the ionic protein complex by insulating it from the conducting carbon surface. When cationic proteins are reduced on surfaces, electron-based dissociation can occur.²⁰ Charge neutralization without the stabilizing forces of water could also result in structural deformation. Supporting this idea, attempts to land GroEL cations into an ionic liquid matrix resulted in no observable particles. However, this same solution protects and preserves neutral protein complexes from the deleterious effects of vacuum.

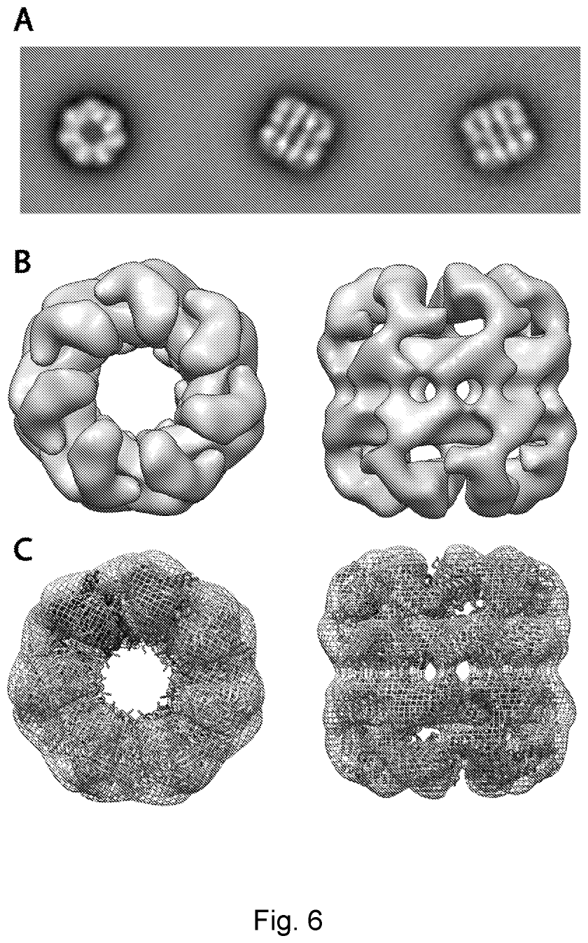

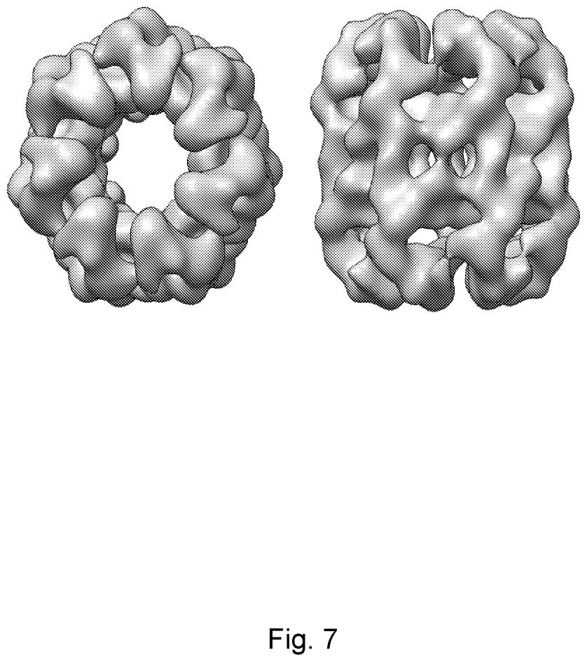

Having established a method to deposit and preserve protein complexes from a gaseous ion beam, the question of whether gas-phase biomolecular ions retain their condensed-phase structures was examined. A dataset of 340 images was collected from a GroEL matrix-landed grid using an L120C microscope equipped with a Ceta camera. It was expected that with these matrix-landed molecular images a medium resolution (˜20 Å) negative stain 3D reconstruction could be generated. From the resultant images, having a pixel size of 3.2 Å, 3,500 particles were picked and processed using cisTEM.²¹ 2D classification was performed and ˜2,700 particles contained in the high-quality class averages (FIG. 6, panel A) were carried forward for further refinement. Ab-initio reconstruction and auto-refinement assuming D7 symmetry resulted in the 3D reconstruction shown in FIG. 6, panel B. FIG. 6, panel C displays the superposition of the matrix-landed 3D reconstruction of GroEL with an atomic model derived from a previous cryo-EM structure (PDB:5W0S). These data show excellent agreement between the landed particles and previously determined GroEL structure. As a further control, a reconstruction of the same sample prepared conventionally was also obtained (FIG. 7). This comparison also resulted in strong agreement. These results provide the highest resolution experimental data collected to date confirming that non-covalent protein complexes subjected to ionization and mass spectrometry can retain their condensed-phase structures.

This example describes a technique—matrix-landing—that promotes the preservation of structure in non-covalent protein complexes that have traversed a mass spectrometer and been deposited onto a TEM grid. Negative staining provides a simple and robust method to image these structures and further data processing of the negatively stained images can offer detailed structural information. It is further envisioned matrix-landing as being applied to mixtures of protein complexes where the MS filtering capabilities enable gas-phase purification of the desired particles. Further, a wide variety of native MS technologies exist—e.g., ion mobility²², surface-induced dissociation²³, collisions²⁴, and photo-activation²⁵—and may be utilized to characterize protein complexes and their interactions beyond intact mass measurement. The ability to image the products of these processes could prove invaluable both for structural biology and to the study of gas-phase chemistry.

Detailed evaluations of several relevant native MS conditions (e.g., buffer, ion source, desolvation energies, time-in-transit, etc.) should also yield further insights and improvements. Exploration of other chemical matrices and methods for generating the highest performing matrix films are similarly anticipated. Landing conditions likewise play an essential role mandating thorough characterization of ion beam energetics, landing pressures, and effects of vacuum exposure. Precise control of the TEM grid surface temperature may also be key for maintenance of the ideal matrix surface and for high-resolution structural preservation. All the depositions described in this example were conducted at room temperature; although reduced TEM grid temperatures is also anticipated in order to extend the protective effects of glycerol and to aid in retention of any water/solvent associated with the protein complex ion.

An extension of this reduced-landing temperature concept is to deposit partially hydrated and mass selected samples directly onto cryogenically-cooled (<180° C.) TEM grids. An expected thin coating of amorphous ice would provide protection from the deleterious effects of both vacuum and the TEM grid surface. Directly coupling cryo-EM grid preparation to MS could provide a host of advantages over conventional grid preparation including improved signal and decreased beam-induced motion (due to lower ice background and lack of in-built ice strain²⁶, respectively). Aside from the aforementioned benefits derived from MS, the boosted signal could increase resolution and enable imaging of smaller particles. The ability to deposit and preserve protein complexes within a vacuum environment may allow for improved TEM sample preparation capabilities and facilitate integration of two disparate fields into one unified technology.

### Example 2—Methods and Preparation Used in Example 1

Materials. Water (Optima LC/MS grade, W6-4) and methanol (Optima for HPLC, A454SK-4) were purchased from Fisher Chemical. Ammonium Acetate (431311-50G), Glycerol (for molecular biology, G5516-100 ml), Amicon Ultra-0.5 centrifugal filter (Ultracel-100 regenerated cellulose membrane, UFC510024). Alcohol Oxidase (Pichia pastoris buffered aqueous solution, 55 mg protein/mL, A2404-1KU), GroEl (Chapernion 60 from Escherichia, C7688-1 MG), and β-Galactosidase (from Escherichia coli, G3153-5 MG) were purchased from Sigma Aldrich. Uranyl Acetate (1% solution, 22400-1) and TEM grids (Carbon support film on 400 mesh copper, CF400-CU) were purchased from Electron Microscopy Sciences.

Sample Preparation. Chaperonin 60 from Escherichia coli (GroEL, Sigma Aldrich) was prepared at 1 mg/mL in 100 mM ammonium acetate. 200 μL of acetone was added to 100 μL of buffered protein solution and allowed to sit for 5 minutes to precipitate the protein. The sample was centrifuged (Fisherbrand Gusto Mini tabletop centrifuge) and the remaining solvent was removed from the pellet. Following this, 400 μL of buffer was added to redissolve the protein and placed in an Amicon centrifugal filter. The sample was centrifuged (Thermo Scientific Sorvall Legend Micro 21R) at 10,000 g for 10 minutes at 4° C. Buffer which passed through the filter was discarded and an additional 400 μL of buffer was added to the sample for another round of washing using the same centrifugal settings. To obtain the sample, the filter was inverted and centrifuged at 2000 g for 1 minute and diluted with 80 μL of buffer.

Alcohol Oxidase was thawed on ice and 10 μL was taken and diluted in 390 μL of buffer. This solution was buffer exchanged by transfer to an Amicon spin filter and centrifuged at 10,000 g for 10 minutes at 4° C. This cycle was repeated three times replenishing with 400 μL of 100 mM ammonium acetate after each spin. To obtain the final sample the solution remaining above the filter was removed via pipette.

β-Galactosidase was prepared at 1 mg/mL in 100 mM ammonium acetate and buffered exchanged as per Alcohol Oxidase. To obtain the final sample, the filter was inverted and centrifuged at 2000 g for 1 minute and diluted with 200 μL of buffer.

Mass Spectrometry. All mass spectrometry experiments in this example were performed on a modified Thermo Scientific Q-Exactive UHMR Hybrid Quadrupole-Orbitrap mass spectrometer.¹⁰ As illustrated in FIG. 8, panel B, generated ions are injected into a stacked ring ion guide (SRIG) 1. The ions are then transported through ion focusing optics, such as an injection flatapole 2 and bent flatapole 3, to a mass filter 4, where the ions are able to be separated according to their mass-to-charge ratios. The SRIG is comprised of numerous metal rings which are stacked coaxially along a central line, with small gaps in between each ring. In order to transmit ions through the SRIG, the electric fields should keep the ions off of the walls of the guide and propel the ions axially toward the exit. The injection flatapole is a square array of flat metal electrodes and acts as an ion focusing device. The bent flatapole transmits ions through a 90° are from the injection flatapole to the quadrupole and removes the neutral gas jet and solvent droplets. In this device, the mass filter is a mass filter quadrupole consisting of four parallel metal rods. Voltages applied to the rods affect the trajectory of ions traveling down the flight path centered between the four rods so that only ions of a certain mass-to-charge ratio pass through the quadrupole. A desired portion of the separated ions are then transported to a C-Trap 5 and either injected into the mass analyzer 7 for mass measurements or deposited onto a substrate or grid inserted into the device by a probe or grid holder (in this instance a TEM grid holder 6). The DC offset potentials provided to different components in this device used during landing experiments is shown on the bottom of FIG. 8.

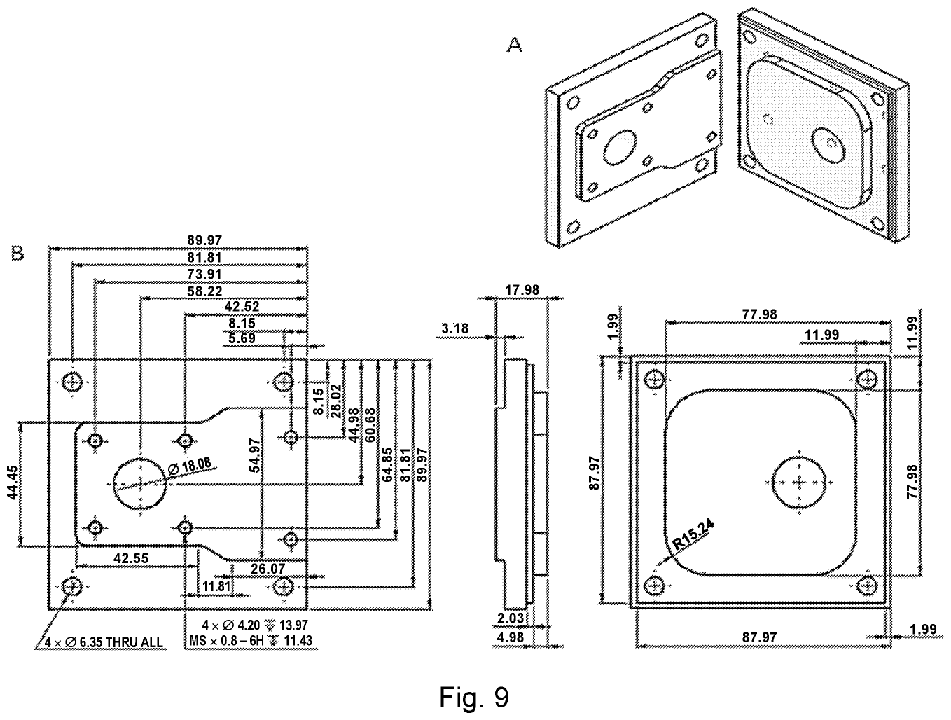

For this experiment, modifications of the Quadrupole-Orbitrap mass spectrometer included the removal of the HCD cell ion optics along with the HCD cell vacuum chamber rear cover plate. The cover was replaced with a modified plate containing a ball valve assembly which could be evacuated by the roughing pump of the UHMR system (see FIG. 9). The valve was placed on center with the HCD cell. This arrangement allowed for the use of an insertion probe to place and hold a TEM grid at the exit of the C-trap/entrance to the HCD cell without breaking vacuum on the mass spectrometer. No changes were required to the mass spectrometer electronics or software. Borosilicate glass capillaries were pulled in-house using a model P-2000 laser-based micropipette puller (Sutter Instrument, CA) to an emitter inner diameter of 1 to 5 microns. A platinum wire placed within the capillary provided continuity between the mass spectrometer ESI power supply and the solution being sprayed. All full scan MS1 experiments were conducted with an ESI voltage of 1.1 kV to 1.5 kV, mass resolving power of 6250 at m/z 400, inlet capillary temperature of 250° C., and in-source trapping with −100V offset.

For landing experiments, the Obitrap mass analyzer was not employed, and the ions were not stopped within the C-trap. To prevent trapping, the trapping gas pressure was set to a value of 0.1. A decreasing DC gradient was placed on all the ion optics from the inlet of the mass spectrometer to the TEM grid. Specifically, lens voltages of to 20V, 19V, 18V, 17V, 16V, 15V, and 0V were employed on the injection flatapole, inter flatapole lens, bent flatapole, transfer multipole, C-trap entrance lens, and TEM grid respectively. All voltages are adjustable through the user interface with exception of the TEM grid which is tied to ground. No insource trapping was employed, the inlet capillary temperature set to 30° C., and a wide mass filter isolation of 10,000-20,000 m/z for GroEL and 8,000-18,000 m/z for Alcohol Oxidase and β-Galactosidase. All protein complex solutions were sprayed at a concentration of approximately 0.1 to 0.3 mg/μL.

Matrix-Landing. Plasma treated carbon film TEM grids were coated with 3 μl of the glycerol/methanol mix (50-50 by volume) and allowed to sit for 30 seconds. Excess solution was removed by touching the edge of the grid to a piece of filter paper. The remaining solution was allowed to equilibrate for 10 minutes. The grid was then placed within the mass spectrometer using the insertion probe and exposed to the ion beam for up to 10 minutes. Upon removal, the grid was negatively stained with 1% uranyl acetate.

Transmission electron microscopy. TEM studies of for the reconstruction of negatively stained GroEL were performed at ambient temperature on a Talos L120C (Thermo Fisher Scientific) operated at 120 kV. Electron micrographs were recorded on a Ceta 16 Mpix camera (Thermo Fisher Scientific). All other TEM studies were performed at ambient temperature on a Techai G2 Spirit BioTwin (Thermo Fisher Scientific) fitted with a NanoSprint15 MK-II 15 Mpix camera (AMT Imaging), also operated at 120 kV. For the 3D reconstruction a defocused image series ranging from 0.1 μm to 2 μm in 0.1 μm steps were collected using the SerialEM software package (https://bio3d<dot>coloradu<dot>edu/SerialEM/). Particle picking, classification, reconstruction and refinement of 3D maps were performed in cisTEM.

### Example 3—Coupling Native MS to Cryo-Electron Microscopy by Generating Amorphous Ice in Vacuo

Introduction. Cryo-EM has become the choice technique for structural biology. Obtaining a high-resolution structure, however, requires that all particles be of the same structural conformation but randomly oriented within amorphous ice. Current methods provide non-uniform ice thickness, preferred particle orientations, and undesirable structural deformation at the air-water interface. The ideal cryo-EM sample has a high density of particles situated in random orientations and covered with a few nanometers of ice. A modified Orbitrap MS system is described that directs an ion beam to a cryogenically cooled TEM grid. Once landed, particles are coated with a thin jacket of amorphous ice using a molecular beam doser. This technology provides a direct method by which to visualize MS analyzed particles using cryoEM.

Methods. A Thermo Fisher Q Exactive UHMR Hybrid Quadrupole-Orbitrap mass spectrometer, mass range m/z 350-80,000, was modified to deposit charged analyte particles onto a graphene oxide surface of a TEM grid. For these experiments the HCD cell was removed and the instrument modified to accept a direct insertion probe holding a single grid. The grid surface was cleaned in advance by air-glow discharge for 10 seconds before loading into the insertion probe. After ion exposure the grid is recovered and negatively stained in 2% uranyl acetate. Images were collected on a FEI Tecnai 120 kV TEM equipped with an AMT camera. Image analysis was performed using ImageJ and EMAN 2.31.

Preliminary Data. To examine the effects of the MS environment on protein structure a variety of analytes was selected, including GroEL, apoferritin, and the flock-house virus. The structures of all these macromolecules are well-characterized by electron microscopy and all amenable to native mass spectrometry. First, experiments were designed aimed at preserving protein complexes when immobilized on a surface in vacuum. For example, when apoferritin in buffer was simply placed on a TEM grid and then exposed to high vacuum, followed by negative stain TEM, almost no intact particles were observed. However, protein complexes suspended in viscous liquids prior to vacuum exposure maintained their structure and were clearly observed via TEM. From these data it was concluded that protein complexes that are entirely desolvated are disassembled and/or lose structural integrity when residing on a TEM surface in vacuo.

In parallel, these particles were ionized under native conditions, injected into the Orbitrap MS system, and either mass analyzed or soft landed onto TEM grids. Following deposition, typically ten to thirty minutes, the grid is removed from the vacuum chamber, negatively stained, and placed directly into a TEM for visualization. From the resulting data, individual particle images are selected and processed. The soft-landed particles had structural distortions and deformations that resembled those which had been pipetted onto the TEM grid and exposed to vacuum.

To date, the data supports the current theory that the conditions required for excellent native spray mass spectrometry are counter to those required to preserve condensed-phase structure. These experiments aim to fully understand the implications of ionizing and mass analysis on structure and, finally, whether these structural distorting processes can be mitigated resulting in the modification of commercial instrumentation for landing of isolated and/or activated biomolecular ions.

### Example 4—Electron Microscopy (EM) Reveals Loss of Structure of Soft-Landed Protein Complexes when Exposed to Vacuum

Introduction. Native mass spectrometry has proven valuable for understanding the structural organization of proteins and macromolecular complexes. That said, other than collisional cross-section measurements obtained through ion mobility, little direct data exists to confirm that these macromolecular complexes retain their condensed-phase configurations when desolvated and placed in vacuum. Addressing this question is central to the field of structural biology and especially native mass spectrometry. Using native mass spectrometry and EM, how exposure to vacuum impacts the structure of protein complexes was investigated. By either spotting protein complex containing solution onto a TEM grid and placing under vacuum or through soft-landing protein complexes using a modified mass spectrometer, hundreds of TEM grids prepared in these ways have been analyzed, providing insight into gas-phase protein structure.

Methods. A Thermo Fisher Q Exactive UHMR Hybrid Quadrupole-Orbitrap mass spectrometer, mass range m/z 350-80,000, was modified to deposit charged analyte particles onto a graphene oxide surface of a TEM grid. For these experiments the HCD cell was removed and the instrument modified to accept a direct insertion probe holding a single grid. The grid surface was cleaned in advance by air-glow discharge for 10 seconds before loading into the insertion probe. After ion exposure the grid is recovered and negatively stained in 2% uranyl acetate. Images were collected on a FEI Tecnai 120 KV TEM equipped with an AMT camera. Image analysis was performed using ImageJ and EMAN 2.31.

Preliminary Data. To examine the effects of the MS environment on protein structure, a variety of analytes were selected including the chaperonin GroEL, apoferritin, and the flock-house virus. The structures of all these macromolecules are well-characterized by electron microscopy and all amenable to native mass spectrometry. First, experiments were designed aimed at preserving protein complexes when immobilized on a surface in vacuum. For example, when apoferritin in buffer was simply placed on a TEM grid and then exposed to high vacuum, followed by negative stain TEM, almost no intact structures were observed. However, protein complexes suspended in viscous liquids prior to vacuum exposure maintained their structure and were clearly observed via TEM. From these data it was concluded that protein complexes that are entirely desolvated are disassembled and/or lose structural integrity when residing on a TEM surface in vacuo.

In a parallel line of research, these particles were ionized using nanoelectrospray under native conditions, injected into the Orbitrap MS system, and either mass analyzed or soft landed onto TEM grids placed to the rear of the C-trap. Following deposition, typically ten to thirty minutes, the grid is removed from the vacuum chamber, negatively stained, and placed directly into a TEM for visualization. From the resulting data, individual particle images are selected and processed. The soft-landed particles had structural distortions and deformations that resembled those which had been pipetted onto the TEM grid and exposed to vacuum.

This data further supports the current theory that the conditions required for excellent native spray mass spectrometry are counter to those required to preserve condensed-phase structure. These experiments aim to fully understand the implications of ionizing and mass analysis on structure and, finally, whether these structural distorting processes can be mitigated resulting in the modification of commercial instrumentation for landing of isolated and/or activated biomolecular ions

### Example 5—Further 3D Structure Determination of Protein Complexes Using Matrix-Landing Mass Spectrometry

This example describes a modified Orbitrap mass spectrometer system capable of depositing a native MS ion beam onto the surface of TEM grids. With this system and the use of a chemical landing matrix, it was demonstrated that non-covalent gaseous ions of protein-protein complexes can retain their condensed-phase structures by obtaining a 3D reconstruction of landed particles. Thus, this system is able to provide an integrated mass spectrometry-electron microscopy methodology.

A quadrupole Orbitrap hybrid system (Ultra-High Mass Range Q-Exactive¹⁰) was modified similar to Examples 1 and 2 by removing the collision cell and modifying the end vacuum cap to allow for an insertion probe to hold a TEM grid to the rear of the c-trap exit lens (see FIG. 8, panel B). With this modification, the ion beam can either be mass analyzed or directed towards a TEM grid. The modified apparatus was tested as described in Example 1.

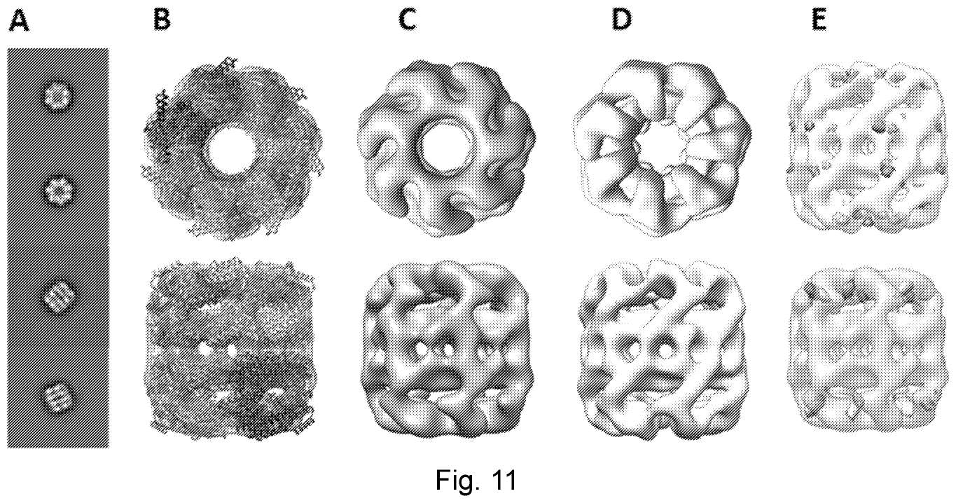

Results. Having established a method to deposit and preserve protein complexes from a gaseous ion beam, the decades old question of whether gas-phase biomolecular ions retain their condensed-phase structures was examined. From a GroEL matrix-landed grid, a dataset of ˜600 images was collected on a Technai G2 Spirit BioTwin microscope equipped with a NanoSprint15 MK-II 15 Mpix camera. It was expected that with these matrix-landed molecular images, medium resolution (˜20 Å) negative stain 3D reconstruction could be generated. Approximately 50 of the highest quality images were selected, having a pixel size of 3.4 Å, and ˜15,000 particles were processed using cisTEM 2D.21 Classification was performed and ˜7,000 (47%) particles contained in the high-quality class averages (FIG. 11, panel A) were carried forward for further refinement. Note these data indicate that a fraction of the landed particles are damaged; however, they are easily removed during the classification process.

Ab-initio reconstruction and auto-refinement, assuming D7 symmetry, resulted in the 3D reconstruction shown in panels B and C of FIG. 11. FIG. 11, panel B displays the superposition of the matrix-landed 3D reconstruction of GroEL (solid gray) with the high-resolution crystal structure (ribbon). These data show excellent agreement between the landed particles and previously determined GroEL structure (PDB:5W0S)²⁷ in all areas except for two helices which project from the density (FIG. 11, panel Bb, discussed below).

The correlation co-efficient between the landed map and a density map simulated from the model with a resolution cut-off of 15 Å was measured as 0.845 using UCSF Chimera.²⁸ As a further control, a reconstruction was obtained of the same sample prepared conventionally. From this grid a dataset of ˜40 images was collected and analyzed in an identical manner as the matrix landed sample, with ˜9,000 particles being picked and ˜7,000 (75%) being carried forward after 2D classification (FIG. 11, panel D, with a resolution cut-off of 15 Å was measured as 0.912 using UCSF Chimera).

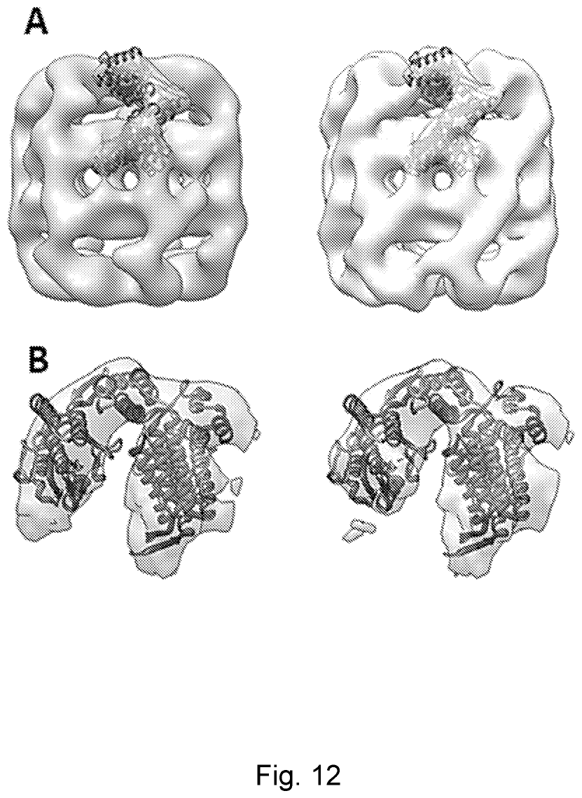

FIG. 12 closely examines the fit of the atomic model to the single particle reconstructions of GroEL for a single subunit. Note that density for the aforementioned projecting helices is also absent in the conventionally prepared sample (FIG. 12) suggesting heterogeneity in that part of the structure. GroEL density maps for soft-landed and pipetted samples have been deposited in the World Wide Protein Data Bank.²⁹ Overall, these two reconstructions from either matrix-landed (FIG. 11, panel C) or conventionally prepared GroEL (FIG. 11, panel D) are remarkably similar. Difference maps, shown in FIG. 11, panel E, confirm this, revealing only a few small differences. Whether these differences are bona fide or simply due to local resolution variations between the datasets is presently unclear. Either way, these results provide the highest resolution experimental data collected to date confirming that non-covalent protein complexes subjected to ionization and mass spectrometry can largely, if not completely, retain their condensed-phase structures.

Discussion. This example further characterizes a technique, matrix-landing, that promotes the preservation of structure in non-covalent protein complexes that have traversed a mass spectrometer and been deposited onto a TEM grid. This method confirms—at the highest resolution to date—that (1) the process of ionization, vaporization, and transport through the MS, which is on the order of ˜10 ms in this system, can be accomplished without loss of particle structural integrity, and (2) lengthy exposure of particles to high vacuum without solvent/matrix is problematic. Presently it is believed that protection from dehydration is the key factor governing the structural preservation of landed particles. However, the possibility that the matrix may provide additional channels for energy dissipation upon particle impact, nor the potential for the matrix to inhibit undesirable surface interactions of the particle with the TEM grid itself, cannot be ruled out. Detailed evaluations of several relevant native MS conditions (e.g., buffer, ion source, desolvation energies, time-in-transit, etc.) should also yield further insights and improvements. Exploration of other landing matrices and methods for generating the highest performing matrix films are similarly critical. Landing conditions likewise play an essential role mandating thorough characterization of ion beam energetics, landing pressures, and effects of vacuum exposure.

Materials. Water (Optima LC/MS grade, W6-4) and methanol (Optima for HPLC, A454SK-4) were purchased from Fisher Chemical. Ammonium Acetate (431311-50G), Glycerol (for molecular biology, G5516-100 ml), Amicon Ultra-0.5 centrifugal filter (Ultracel-100 regenerated cellulose membrane, UFC510024). Alcohol Oxidase (Pichia pastoris buffered aqueous solution, 55 mg protein/mL, A2404-1KU), GroEl (Chapernion 60 from Escherichia, C7688-1 MG), and β-Galactosidase (from Escherichia coli, G3153-5 MG) were purchased from Sigma Aldrich. Uranyl Acetate (1% solution, 22400-1) and TEM grids (Carbon support film on 400 mesh copper, CF400-CU) were purchased from Electron Microscopy Sciences.

Sample Preparation. GroEL was prepared at 1 mg/ml in 100 mM ammonium acetate. 200 μL of acetone was added to 100 μL of buffered protein solution and allowed to sit for five minutes to precipitate the protein. The sample was centrifuged (Fisherbrand Gusto Mini tabletop centrifuge) and the remaining solvent was removed from the pellet. Following this, 400 μL of buffer was added to redissolve the protein and placed in an Amicon centrifugal filter. The sample was centrifuged (Thermo Scientific Sorvall Legend Micro 21R) at 10,000 g for 10 minutes at 4° C. Buffer which passed through the filter was discarded and an additional 400 μL of buffer was added to the sample for another round of washing using the same centrifugal settings. To obtain the sample, the filter was inverted and centrifuged at 2000 g for 1 minute and diluted with 80 μL of buffer.

Alcohol Oxidase was thawed on ice and 10 μL was taken and diluted in 390 μL of buffer. This solution was buffer exchanged by transfer to an Amicon spin filter and centrifuged at 10,000 g for 10 minutes at 4° C. This cycle was repeated three times replenishing with 400 μL of 100 mM ammonium acetate after each spin. To obtain the final sample the solution remaining above the filter was removed via pipette. β-Galactosidase was prepared at 1 mg/mL in 100 mM ammonium acetate and buffered exchanged as per Alcohol Oxidase. To obtain the final sample, the filter was inverted and centrifuged at 2000 g for 1 minute and diluted with 200 μL of buffer.

Mass Spectrometry. All mass spectrometry experiments were performed on a modified Thermo Scientific Q-Exactive UHMR Hybrid Quadrupole-Orbitrap mass spectrometer running Q-Exactive Tune 2.11QF2 control software.¹⁰ Modifications included the removal of the HCD cell ion optics along with fabrication of a new the HCD cell vacuum chamber rear cover plate. Note, without the HCD cell, the system is no longer able to perform collisional activation of mass selected precursors. Otherwise, the system works as usual and injection of ions into the Orbitrap is unaffected.

Using readily available components, a simple device was implemented to insert the TEM grid into the vacuum environment of the UHMR mass spectrometer. To insert and remove TEM grids for landing, the vacuum interlock and probe components of a retired Thermo Fisher Scientific ETD module were adapted. The ion volume insertion and removal tool is used to hold the TEM grid. Incorporation of the inlet valve and guide bar assembly required fabrication of a new endplate for the vacuum chamber housing of the UHMR HCD cell (FIG. 9, panel A). FIG. 9, panel B, contains the mechanical drawings required to duplicate the endplate. Dimensions are shown in units of millimeters.

The new cover plate (shown in FIG. 9, panel A) contained a ball valve assembly which could be evacuated by the roughing pump of the UHMR system. The valve was placed on center with the HCD cell. This arrangement allowed use of the insertion probe to place and hold a TEM grid at the exit of the c-trap/entrance to the HCD cell without breaking vacuum on the mass spectrometer. No changes were required to the mass spectrometer electronics or software. Borosilicate glass capillaries were pulled in-house using a model P-2000 laser-based micropipette puller (Sutter Instrument, CA) to an emitter inner diameter of 1 to 5 microns. A platinum wire placed within the capillary provided continuity between the mass spectrometer ESI power supply and the solution being sprayed.

All full scan MS1 experiments were conducted with an ESI voltage of 1.1 kV to 1.5 kV, mass resolving power of 6250 at m/z 400, inlet capillary temperature of 250° C., and in-source trapping with −100V offset. For landing experiments, the Obitrap mass analyzer was not employed, and the ions were not stopped within the c-trap. To prevent trapping, the trapping gas pressure was set to a value of 0.1. A decreasing DC gradient was placed on all the ion optics from the inlet of the mass spectrometer to the TEM grid. Specifically, lens voltages of 20V, 19V, 18V, 17V, 16V, 15V, and 0V were employed on the injection flatapole, inter flatapole lens, bent flatapole, transfer multipole, C-trap entrance lens, and TEM grid respectively. All voltages are adjustable through the user interface with exception of the TEM grid which is tied to ground. No insource trapping was employed, the inlet capillary temperature set to 30° C., and a wide mass filter isolation of 10,000-20,000 m/z for GroEL and 8,000-18,000 m/z for Alcohol Oxidase and β-Galactosidase. All protein complex solutions were sprayed at a concentration of approximately 0.1 to 0.3 mg/μL.

Matrix-Landing. Plasma treated carbon film TEM grids were coated with 3 μl of the glycerol/methanol mix (50-50 by volume) and allowed to sit for 30 seconds. Excess solution was removed by touching the edge of the grid to a piece of filter paper. The remaining solution was allowed to equilibrate for 10 minutes. The grid was then placed within the mass spectrometer using the insertion probe and exposed to the ion beam for up to 10 minutes. Upon removal, the grid was negative stained with 75 μL of 1% uranyl acetate by edge blotting. It was estimated that the flow rate of the nano electrospray emitter to be in the range of 20 to 40 nL/min. A 10 minute deposition experiment would therefore consume ˜300 nL of GroEL solution. At ˜0.3 mg/mL; ˜90 ng GroEL would be consumed.

Transmission electron microscopy. TEM studies of for the reconstruction of negatively stained GroEL were performed at ambient temperature on a Technai G2 Spirit BioTwin (Thermo Fisher Scientific) fitted with a NanoSprint15 MK-II 15 Mpix camera (AMT Imaging), operated at 120 kV. Microscope and camera control software included Tecnai version 3.1.3 and AMT Capture Engine version 7.00 respectively. For the 3D reconstruction a defocused image series ranging from 0.1 μm to 2 μm in 0.1 μm steps were collected using the SerialEM software package version 3.8.7 (https://bio3d.colorado.edu/SerialEM/). Particle picking, classification, reconstruction and refinement of 3D maps were performed in cisTEM version 1 (https://cistem.org/). Model fitting, imaging and figure creation were done using UCSF Chimera version 1.16 (https://www.cgl.ucsf.edu/chimera/).

Data Collection and Processing. The conditions for collecting cryo-EM data for this experiment is provided below in Table 1.

TABLE 1
Cryo-EM data collection conditions.

| | 3D Structure of GroEL Protein |
|---|---|
| | Complexes using Matrix-Landing |
| | Mass Spectrometry |
| | (EMDB ID: EMD-26222) |
| Data collection and processing | |
| Magnification | 30,000 |
| Voltage (kV) | 120 |
| Electron exposure (e [symbol] /Å²) | Negative stain, |
| | not measured |
| Defocus range (μm) | 1 to 3 |
| Pixel size (Å) | 3.4 |
| Symmetry imposed | D7 |
| Initial particle images (no.) | 14,571 |
| Final particle images (no.) | 7,703 |
| Map resolution (Å) | 14 |
| FSC threshold | 0.143 |

[symbol]

indicates data missing or illegible when filed

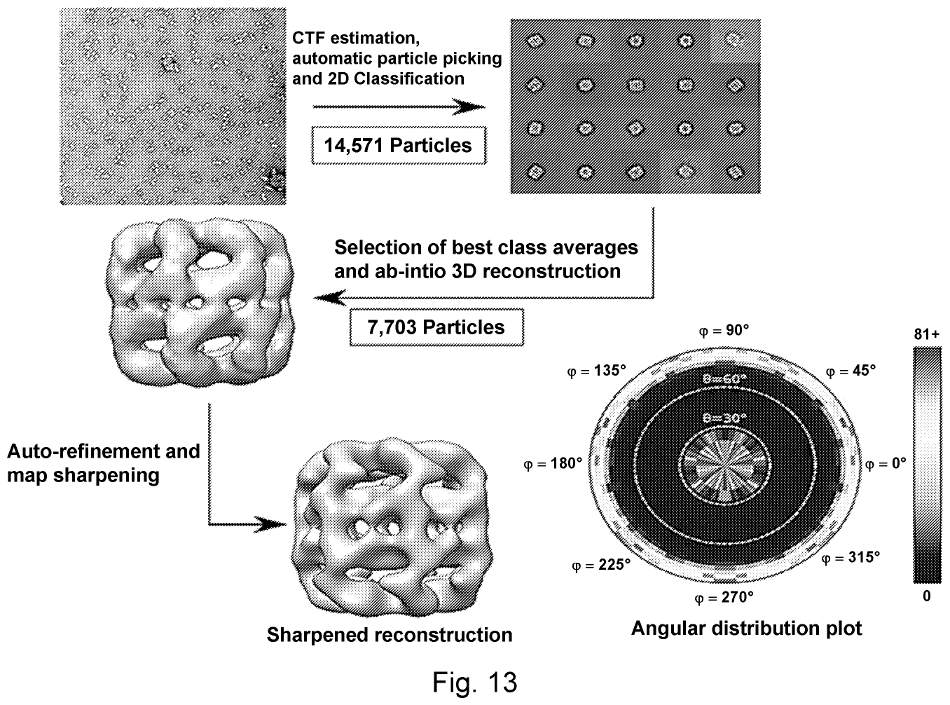

The electron microscopy data processing workflow is illustrated in the flow chart of FIG. 13. Automatic particle picking resulted in ˜15,000 picked particles. After 2D classification and selection of the best classes, ˜7,000 particles were kept. Ab-inito 3D reconstruction followed by auto-refinement and map sharpening resulted in the final 3D reconstruction which is shown along with a plot demonstrating the angular distribution of the particles.

### Example 6—Thin Film Matrix-Landing Mass Spectrometry of Native Protein Complexes

Native spray mass spectrometry (MS) and Electron Microscopy (EM) have increasingly been used in parallel to increase the amount of information that can be obtained from a single protein complex analysis. The benefits of mass spectrometry, including the ability to perform isolation, determine subunit stoichiometry, and induce fragmentation paired with the direct imaging of EM makes for a strong coupling of technologies. Utilizing a modified Orbitrap MS system, native spray MS of protein complexes allowed for the deposition of an ion beam directly onto an EM grid. This example presents the use of thin film chemical matrices enabling the preservation of deposited protein complexes. Applying a thin film matrix to a TEM grid allowed for an increase in particle density on grid as well as obtaining 3D reconstructions of the 801 kDa chaperonin GroEL, 674 kDa 20S proteasome core, and 467 kDa β-Galactosidase from gas phase deposited ions.

In particular, the ability of five chemical compounds to preserve soft-landed protein complexes in a vacuum environment were examined. The five compounds tested were polyethylene glycol (PEG), triethanolamine (TEA), polypropylene glycol (PPG), Triton X-100 (2-[4-(2,4,4-trimethylpentan-2-yl)phenoxy]ethanol), and diglycerol. All five compounds provided protection from vacuum in a pipetted sample test, although only PPG, TritonX, and diglycerol presented positive results in an actual soft-landing test. Although the performance of TEA and PEG was suboptimal in the initial soft-landing test, these compounds are still believed to be viable options given that the proper conditions under which to perform soft landings can be found.

It was attempted to optimize the experimental conditions for PPG, as this compound was the best performing matrix in the initial landing experiments, meaning that it provided the greatest probability of being able to find an area on a soft-landed TEM grid which is imageable. In the optimization of PPG it was also discovered that rinsing the TEM grid with 1M ammonium acetate buffer after soft-landing and prior to staining could be beneficial. This rinsing procedure enabled β-Galactosidase to be landed and imaged. Prior to employing the rinsing procedure, β-Galactosidase could be landed but the particles could not be stained and imaged properly. The same rinsing procedure has been tested on larger molecules, such as GroEL or the 20S Proteasome, and was not found to be detrimental to the outcome.

Overall this example provides further evidence that the noncovalent structure inherent to protein complexes is retained through the ionization, desolvation, and the landing process of the mass spectrometer as well as highlighting the benefits of using dilute chemical matrices to form thin films for preservation.

Introduction. Electrospray ionization mass spectrometry (ESI-MS) as a technique has played a pivotal role in allowing the correlation of gas phase biomolecular structure to condensed phase structure.¹⁶ ESI-MS allows for the investigation of native protein structure, multiprotein complexes, and protein-ligand complexes due to the soft ionization that occurs allowing a gentle transition to the gas phase.³² The gentle transition from solution phase to gas phase, and the relative effects on structure from ionization, desolvation, and mass analysis has motivated research investigating overall structure of complexes that have traversed a mass spectrometer.⁶ Recently it was shown that condensed phase structure of the 801 kDa chaperonin GroEL is retained after ionization, vaporization, and sequential deposition onto a TEM grid with a layer of glycerol using a modified Orbitrap MS system followed by direct imaging using electron microscopy.³³ The use of excipients and cryoprotectants, such as glycerol, is ubiquitous in the preservation of protein complexes.³⁴⁻³⁷ Capelle et al. shows a variety of chemical compounds that help in the preservation of proteins which includes buffers, amino acids, surfactants, antioxidants, polymers, sugars, and polyols.³⁵

This example investigates the use of chemical matrices on TEM grids to preserve landed protein complexes from the deleterious effects of vacuum. Whereas previous experiments relied on excess glycerol to preserve protein structure, these results demonstrate that thin films (˜180 nm) of certain chemicals provide equally effective protection while increasing landing efficiency. This approach results in more reproducible distributions and higher densities of particles, thus allowing for the preparation of TEM grids comparable in particle distribution and density to conventionally prepared TEM samples. Additionally, this examples provides further evidence that the condensed phase structure of multiple landed protein complexes is retained when soft-landing into a thin film matrix.

When choosing the matrices to analyze, a few different properties were sought after including (1) high viscosity (2) high boiling point as to retain the matrix under vacuum (3) similarity of structure to glycerol, and (4) compatibility with protein complexes. It was suspected, as with the initial glycerol soft-landings experiments, that the protection from dehydration is the main contributor to the overall protection of the landed ions.

Methods and Materials. Water (Optima LC/MS grade, W6-4) and methanol (Optima for HPLC, A454SK-4) were purchased from Fisher Chemical. Ammonium Acetate (431311-50G), Amicon Ultra-0.5 centrifugal filter (Ultracel-100 regenerated cellulose membrane, UFC510024), Glycerol (for molecular biology, G5516-100 mL), Triethanolamine (90279-100 mL), Poly(ethylene glycol) average MW 200 (P3015-250G), Poly(propylene glycol) average MW 2700 (202347-5G), Triton X-100 (×100-5 mL), Diglycerol (TCI-T0119-25G). GroEl (Chapernion 60 from Escherichia, C7688-1 MG) and β-Galactosidase (from Escherichia coli, G3153-5 MG) were purchased from Sigma Aldrich. 20S Proteasome core particles (Thermoplasma acidophilium expressed in E. coli BL21 (DE3)) provided by non-commercial source. Uranyl Acetate (1% solution, 22400-1) and TEM grids (Carbon support film on 400 mesh copper, CF400-CU) were purchased from Electron Microscopy Sciences.

Sample preparation. GroEL was reconstituted in 100 mM ammonium acetate at 1 mg/mL. On ice, 500 μL of GroEL solution was mixed with 1000 μL of acetone and was allowed to precipitate for 5 minutes. The precipitated protein was centrifuged (Fisherbrand Gusto Mini tabletop centrifuge) and the remaining solvent was removed. 1000 μL of 100 mM ammonium acetate was added to the pellet, redissolved, and then split between two Amicon centrifugal filter. The sample was centrifuged (Thermo Scientific Sorvall Legend Micro 21R) at 10,000 g for 10 minutes at 4° C. Flow through was discarded and an additional 400 μL of ammonium acetate was added followed by another round of centrifugation using the same settings as above. Samples were obtained by inverted the tubes and centrifuging at 2,000 g for 1 minutes at 4° C. The two samples were combined and diluted in 350 μL buffer.

20S Proteasome was thawed on ice and 100 μL was taken and transferred to an Amicon spin filter and centrifuged at 10,000 g for 10 minutes at 4° C. Three rounds of purification were done with 400 μL each of 100 mM ammonium acetate followed by centrifugation at 10,000 g for 10 minutes at 4° C. with flow through being discarded. Samples were obtained as per GroEL and diluted in 100 μL buffer.

β-Galactosidase was reconstituted in 100 mM ammonium acetate at 1 mg/mL and buffered exchanged as per 20S Proteasome. The final sample was obtained by inverting the tube and centrifuged at 2000 g for 1 minute and diluted with 100 μL of buffer.

Mass Spectrometry. All mass spectrometry experiments were performed on a modified Thermo Scientific Q-Exactive UHMR Hybrid Quadrupole-Orbitrap mass spectrometer. Modifications and full scan MS1 experiments are previously described³³ with no changes required to the mass spectrometer electronics or software. In-house emitters with an inner diameter of 1-5 microns were pulled with borosilicate glass capillaries using a model P-2000 laser-based micropipette puller (Sutter Instrument, CA). Continuity between the ESI-MS power supply and the solution being sprayed was achieved by placing a platinum wire in the backside of the emitter. Landing experiments were conducted without the Orbitrap mass analyzer and the trapping gas pressure was set to a value of 0.1 to prevent trapping. A linear decrease in voltage was applied to the injection flatapole, inter flatapole lens, bent flatapole, transfer multipole, and C-trap entrance lens with values of 20V, 19V, 18V, 17V, 16V, 15V, respectively, followed by the TEM grid at ground (0V). No mass filter isolation or insource trapping was used and the inlet capillary temperature was set to 80° C. with all protein complex solutions being sprayed at 0.1 to 0.3 mg/mL.

Matrix Negative Stain. The matrices PEG, PPG, Glycerol, Triethanolamine, and 100 mM ammonium acetate buffer (control) were mixed in a ratio (by volume) of 1:1:1 of methanol, matrix, and GroEL at a concentration of 0.2 mg/mL, respectively, with TritonX-100 and Diglycerol having a ratio of 2:1:2. Each matrix solution with GroEL was pipetted on a plasma treated carbon film TEM grid and allowed to sit for 1 minute. The grid was negative stained with 75 μL of 1% uranyl acetate and edge blotted to remove excess stain.

Excess Matrix Vacuum Negative Stain. The matrices PEG, PPG, Glycerol, and 100 mM ammonium acetate buffer (control) were mixed in a ratio (by volume) of 1:1:1 of methanol, matrix, and GroEL at a concentration of 0.02 mg/mL respectively with triethanolamine, TritonX-100, and diglycerol having a ratio of 3:1:3. The solutions were pipetted on a plasma treated carbon film TEM grid and allowed to sit for 1 minute followed by edge blotting to remove excess solution. Grids were then placed under vacuum for 15 min at 2×10⁻⁵ Torr followed by negative stain as previously described.

Minimal Matrix Vacuum Negative Stain. 1% solutions by volume of each matrix in methanol were prepared. Separate plasma treated carbon film TEM grids were coated with 0.5 μL of matrix/methanol mix and allowed to sit for 30 seconds. To this, 0.5 μL of GroEL at 0.02 mg/mL was pipetted and grids were then placed under vacuum for 15 min. Upon removal, the grid was rinsed with 150 μL of 1M ammonium acetate and immediately negative stained with 75 μL of 1% uranyl acetate and edge blotted to remove excess stain.

Matrix-Landing. Plasma treated carbon film TEM grids were coated with 0.5 μL of matrix/methanol mix (0.25% by volume with matrices being PPG, TritonX-100, or diglycerol) and allowed to sit for 30 seconds. The grid was inserted into the mass spectrometer using the insertion probe and deposition occurred for up to 10 minutes. The grid was then rinsed with 1M ammonium acetate buffer and sequentially stained as previously described.

Transmission electron microscopy (TEM). TEM studies of the reconstruction of negatively stained GroEL, β-Galactosidase, and 20S Proteasome were performed on a Technai G2 Spirit BioTwin (Thermo Fisher Scientific) at ambient temperature fitted with a NanoSprint15 MK-II 15 Mpix camera (AMT Imaging), operated at 120 kV. Defocused image series for 3D reconstruction ranging from 0.1 μm to 2 μm in 0.1 μm steps were collected using the SerialEM software package (https: bio3d.colorado.edu/SerialEM/). Particle picking, classification, reconstruction and refinement of 3D maps were performed in cisTEM (https:cistem.org/). Model fitting, imaging and figure creation were done using UCSF Chimera (https:www.cgl.ucsf.edu/chimera/).

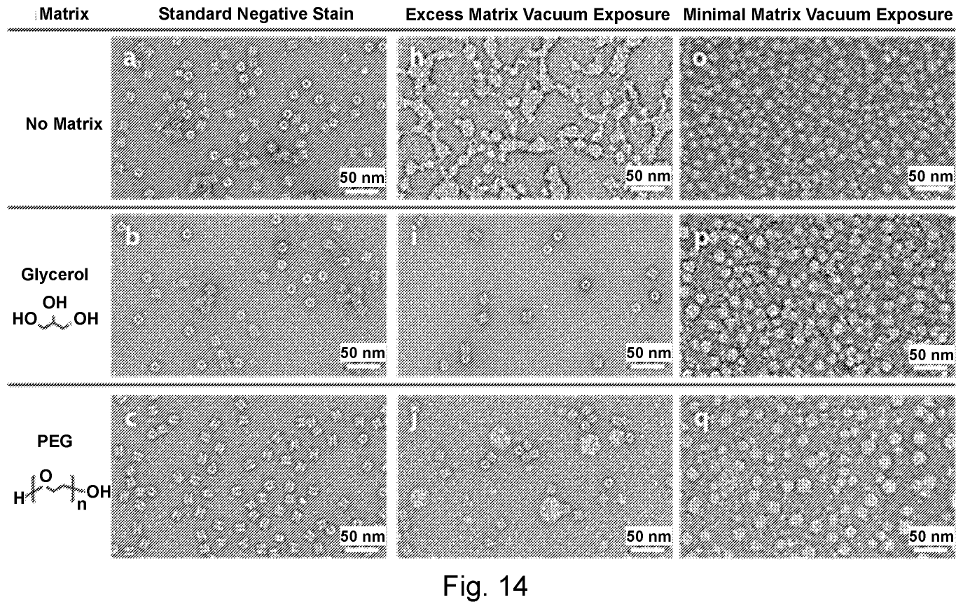

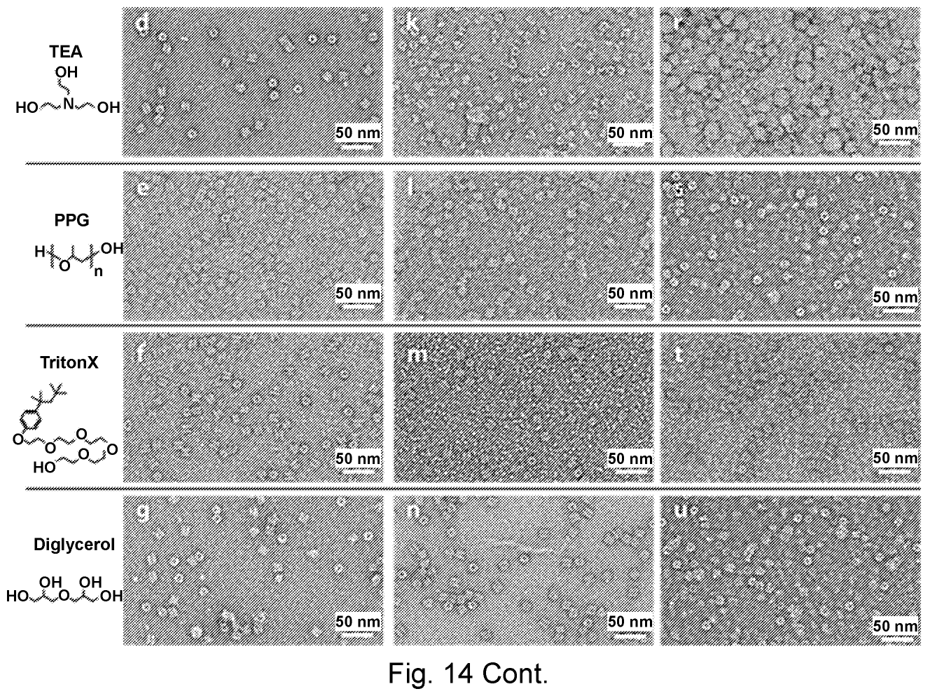

Results. With the success of glycerol to preserve protein complexes on a TEM grid, allowing for the first-ever 3D reconstruction of a soft-landed protein complex,³³ other chemical matrices were investigated that may harbor comparable properties to glycerol. A few of these properties include being polar, having a high viscosity (1200 cP at 20° C.), being a liquid at room temperature, and having favorable interactions with complexes as to not induce unfolding.³⁸ Using these properties as a preliminary guide, a total of five different matrices were chosen for investigation which includes triethanolamine (TEA), poly(ethylene) glycol (PEG), poly(propylene) glycol (PPG), TritonX-100, and diglycerol, with structures of each molecule, as well as glycerol, shown in FIG. 14.

For initial matrix-protein compatibility investigations GroEL, the matrix of interest, and methanol were mixed together. A small volume of this solution (3 μL) was deposited on a TEM grid, edge blotted to remove excess protein solution, and then negative stained for TEM imaging. In all instances, the resulting images of GroEL in each matrix (FIG. 14, panels A-G) showed the typical top view (seven-membered ring) and side view (four lines indicative of the stacked subunit rings) of GroEL indicating structural integrity with varying degrees of stain contrast.

Next, to determine how vacuum exposure in each matrix impacted the structure of GroEL, a similar mixture of GroEL, matrix, and methanol was combined, pipetted onto a TEM grid, edge blotted to remove excess solution, and then placed in a vacuum (2×10⁻⁵ Torr) for 15 minutes. Upon removal from vacuum the grid was negatively stained and imaged. Most notably in FIG. 14, panel B, which shows a control grid with no matrix present, no structural features typically seen in GroEL are present as expected. As with the initial matrix-protein compatibility investigation, where GroEL was in essence conventionally stained with the addition of each matrix, all matrices were able to retain the structure of GroEL after vacuum exposure. While the exact mechanism of protection cannot be commented on, the images from TEA, PPG, and TritonX-100 (FIG. 14, panels K, L, and M, respectively) have poor staining quality suggesting excess matrix is interfering with staining but likely still fully protecting the GroEL complex.

To further probe the interference of the matrix when staining and importantly determine which matrices could be used at extremely low volumes for soft-landing, a final vacuum experiment was conducted using a thin film of matrix. Previous experiments with glycerol for soft-landing were prepared in excess by pipetting 3 μL of 1:1 glycerol/methanol followed by edge blotting leaving ˜0.5 μL of matrix on grid. It was suspected that the use of extremely thin layers of matrix would enable more particles to be retained and make the layer of matrix more reproducible compared to the previous edge blotting method which removed an arbitrary amount of matrix. This thin film matrix would reduce the thickness of liquid that the protein complex would need to traverse to interact with the grid and increase the concentration of protein in the matrix, which would increase the probability of particle-surface interaction.

To a TEM grid, 0.5 μL of a 1% solution of matrix by volume in methanol was deposited and allowed to dry. The matrix-covered grid was then spotted with 0.5 μL GroEL to more closely mimic soft-landing, placed in a vacuum for 15 minutes, removed and rinsed with 150 μL of buffer, and then immediately stained. In this instance both glycerol (FIG. 14, panel P) and PEG (FIG. 14, panel Q) were no longer able to protect GroEL from the effects of vacuum. TEA (FIG. 14, panel L) showed limited preservation abilities with some recognizable views of GroEL present. Most notably, PPG, TritonX-100, and Diglycerol (FIG. 14, panel S, T, and U, respectively) were able to retain the structure of GroEL with both PPG and TritonX-100 showing an increase in particle contrast. These data suggest that all three matrices could preserve soft-landed particles while having the potential to increase the number of particles retained on the TEM grid.

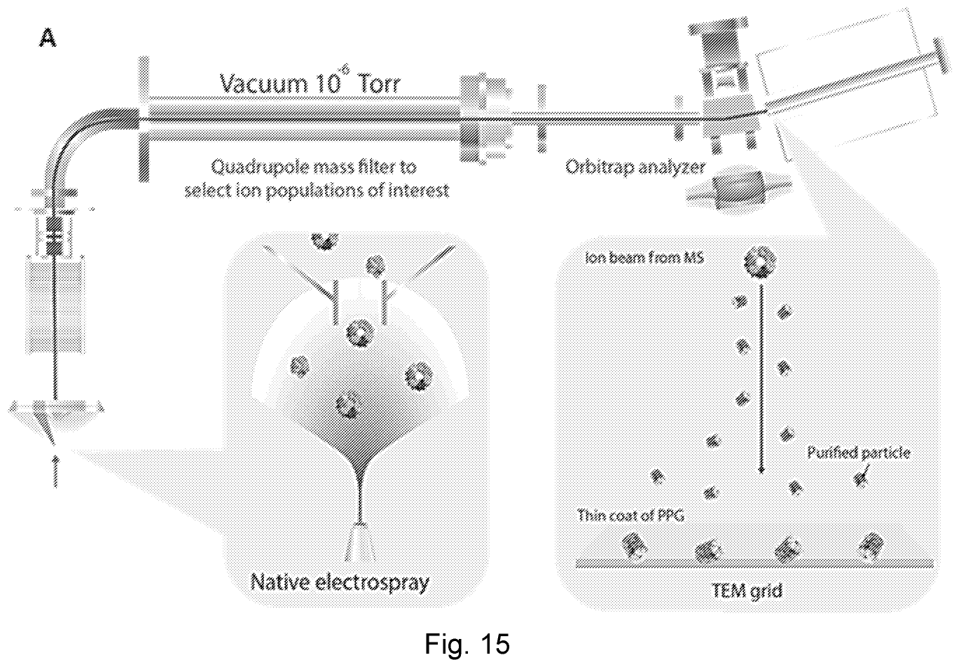

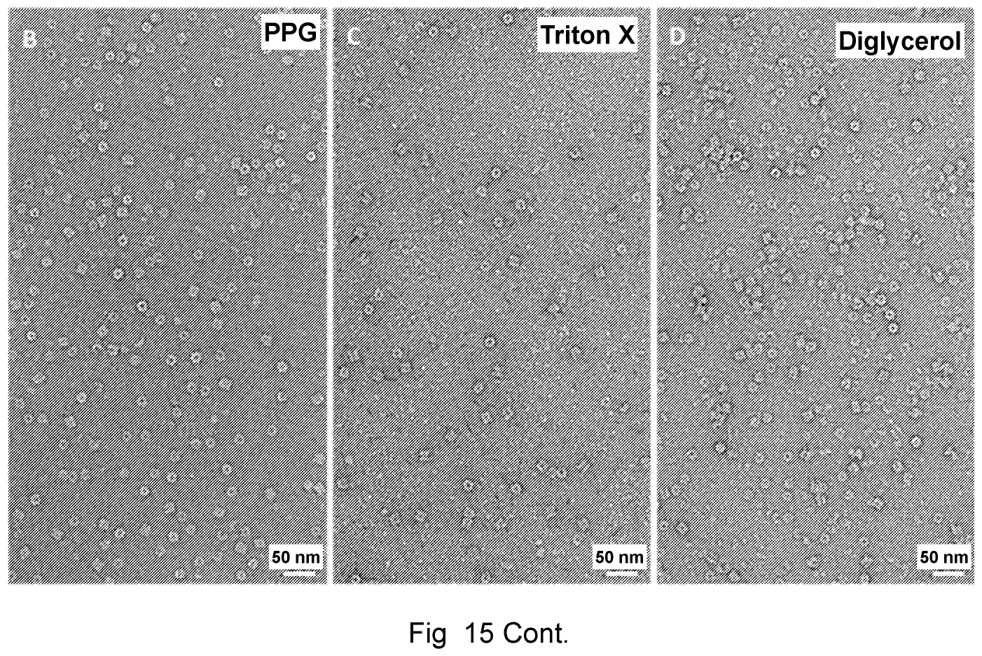

Matrix-landing and TEM imaging of GroEL, 20S Proteasome, and β-Galactosidase. With the three new matrices PPG, TritonX-100, and Diglycerol allowing for the preservation of GroEL under vacuum using thin films, it was determined if the three matrices would be able to preserve landed protein complexes. To a TEM grid, 0.5 μL of a 0.25% matrix solution in methanol was deposited and allowed to dry. Next, the matrix-covered grid was inserted into the modified Orbitrap MS system (FIG. 15, panel A) and the GroEL ion beam was deposited onto the TEM grid for 10 minutes. After removal from the instrument, the grid was rinsed with 150 μL of buffer and then immediately stained. Upon imaging of each grid, large areas of deposited particles were observed for all 3 matrices showing structurally intact GroEL (FIG. 15, panels B, C, and D). Favorable qualities of negative stain TEM include (1) little to no aggregation of particles (2) minimal protein complex fragments and most importantly (3) a dark background indicating good staining contrast. When looking at each matrix, PPG has all these qualities whereas TritonX-100 (poor staining) and diglycerol (poor staining, aggregation, and fragments) do not. With these characteristics in mind, it was decided to move forward and explore the capabilities of PPG for the preservation of GroEL and other well characterized structures.

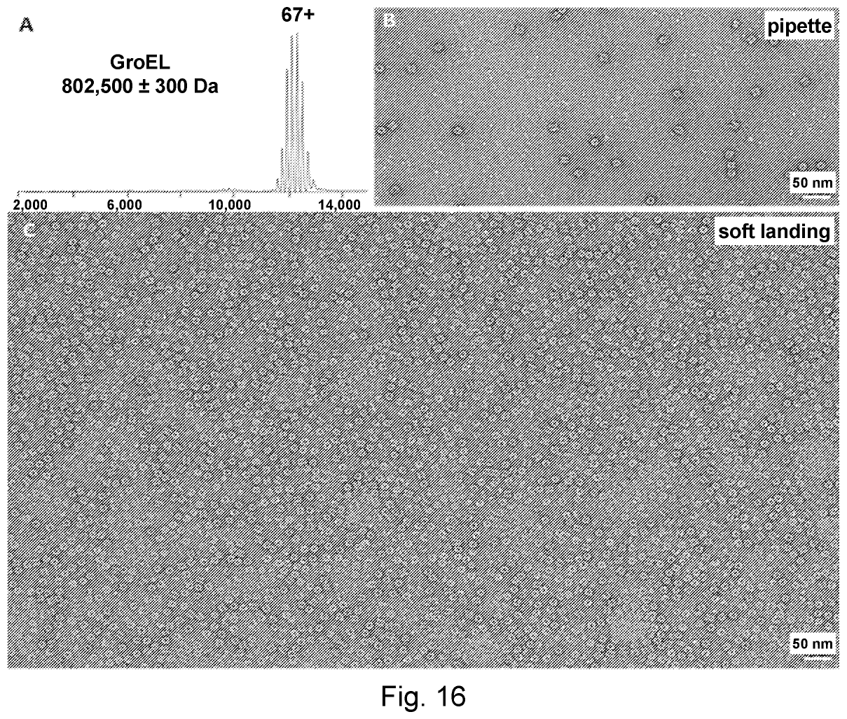

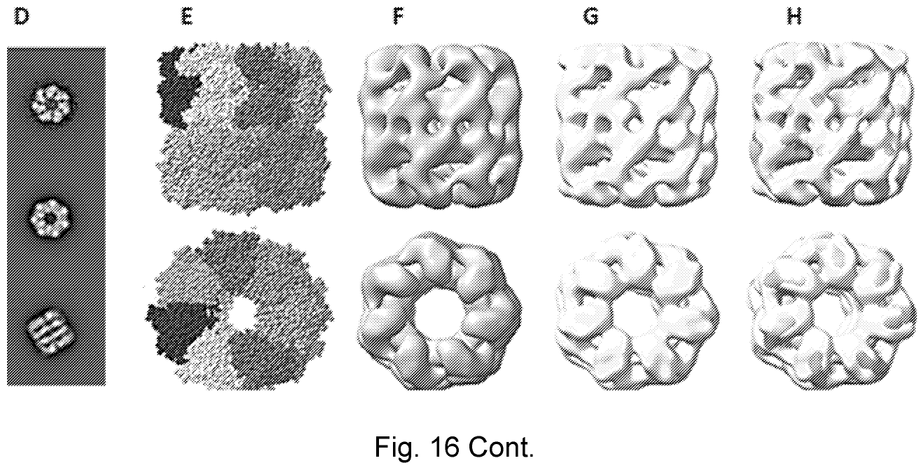

First, the chaperonin GroEL, with a mass of ˜800 kDa and average charge state of +67 (FIG. 16, panel A), was deposited as previously described and images were acquired using SerialEM software on a Technai G2 Spirit BioTwin microscope equipped with a NanoSprint15 MK-II 15 Mpix camera. A representative image of the gas-phase deposited GroEL acquired using SerialEM is shown in FIG. 16, panel C. The density of landed and fully preserved particles is unparalleled to any other known soft-landing of intact protein complexes followed by EM imaging with densities equivalent to or higher than pipetted standards (FIG. 16, panel B). From the subset of ˜50 images at a pixel size of 3.4 Å, select images were processed using the program cisTEM.³⁹ Processing includes first picking particles, followed by sorting and refinement into 2D class averages allowing for the removal of damaged particles. Next, the best class averages are used to obtain an ab-initio starting volume followed by auto-refinement using a D7 symmetry for GroEL. The 3D reconstruction of the soft-landed GroEL complex is shown in FIG. 16, panel F, with representative 2D class averages in FIG. 16, panel D. To further evaluate the integrity of imaged cation, the high-resolution crystal structure of GroEL (PDB:5W0S)²⁷ was superimposed on the soft-landed cation (FIG. 16, panel E) showing excellent agreement between structures. For further confirmation of structural integrity of the soft-landed cation, a conventionally pipetted TEM grid of GroEL was imaged to obtain a 3D structure (FIG. 16, panel G) using cisTEM as previously described. The overlay of the conventional stained and soft-landed GroEL difference map in FIG. 16, panel H, shows the remarkable similarity with minor differences showing between the two 3D reconstructions. This data corroborates the previous conclusion with glycerol further showing that condensed phase structure of non-covalent protein complexes is retained after ionization and traversing the mass spectrometer.

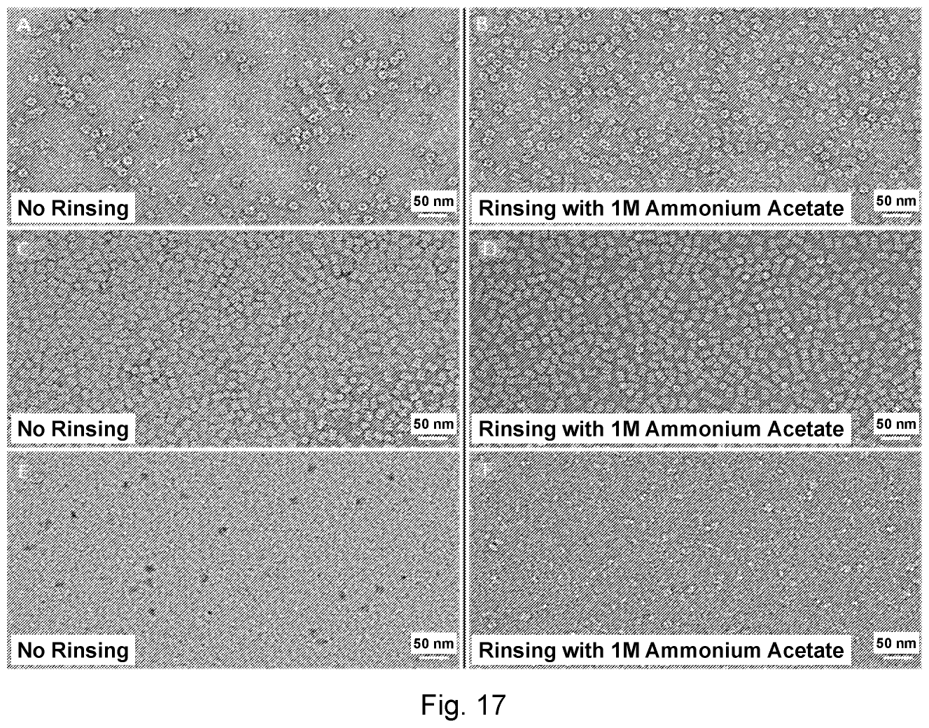

To further investigate the capabilities of PPG as a thin film matrix to protect soft-landed ions, the well-studied protein complex β-Galactosidase was examined. β-Galactosidase is a tetramer with 4 identical subunits and a mass of ˜467 kDa and average charge state of +45.19 Using the same workflow as previously described with GroEL, β-Galactosidase was soft-landed into a thin film of PPG, washed with buffer, and negative stained. Interestingly, the density of the soft-landed β-Galactosidase consistently yields less overall protein complex on grid compared to GroEL. This could be due to a couple of aspects including potentially having lower ionization efficiency and/or matrix interference with staining due to its smaller structure. FIG. 17, panel A, shows initial soft-landing attempts of β-Galactosidase, before the rinsing with buffer was introduced, with all particles being positive stained (black in appearance due to lack of stain) further suggesting matrix interference. A subset of select images obtained from SerialEM of the soft-landed, rinsed, and stained particles were processed using cisTEM as described previously apart from changing the point group to D2 for β-Galactosidase. FIG. 16 illustrates the corresponding 2D class averages along with the 3D reconstruction of soft-landed β-Galactosidase. As with GroEL, the crystal structure overlay and difference map of the pipetted control compared to the soft-landed β-Galactosidase show very minute differences further exemplifying the retention of condensed phase structure for protein complexes after traversing the mass spectrometer.

Finally, the 20S proteasome core particle (CP), which is a barrel-shaped protein complex composed of four stacked homoheptameric rings,⁴⁰ was obtained and analyzed. Unlike with GroEL and β-Galactosidase, there was no prior experience with the 20S proteasome CP. Using identical methodology as the previous two complexes, the 20S proteasome CP was able to be purified, electrosprayed, soft-landed, and reconstructions obtained in less than half a day. The FIG. 17, panels C and D, illustrate the 20S proteasome CP having a mass of ˜676 kDa and average charge state of +63. Using the same thin film matrix as with GroEL and β-Galactosidase, the 20S proteasome CP was soft-landed with incredible density rivaling that of the conventionally stained TEM grid across much of the grid. Select images of the soft-landed particles were processed using cisTEM applying a D7 symmetry with the 2D class averages and soft-landed 3D reconstruction generated (not shown). Yet again, the crystal structure overlay and pipetted standard overlay with the soft-landed CP showed remarkable similarities with few discernable differences. The soft-landing of each of these protein complexes shows the benefits of using a thin film matrix while also further confirming that non-covalent protein-protein complexes can transverse the mass spectrometry and remain largely, if not fully, intact.

Discussion/Conclusion. This example demonstrates the use of thin films to preserve three different protein-protein complexes which have been ionized into the gas phase, traveled through a mass spectrometer, and landed on a TEM grid showing excellent agreement to published crystal structures and pipetted reconstructions. Through this, it is shown not only that a variety of matrices at higher concentrations have the capability to preserve protein complexes from the detrimental effect of vacuum but that chemical matrices such as PPG, TritonX-100, and diglycerol can protect protein complexes at exceptionally low amounts. These thin films provide equally effective protection while increasing landing efficiency.

While the exact mechanism of protection is currently unknown for soft-landed protein complexes in this example, previous research looking at the interaction of solution phase protein-matrix interactions may provide insight into a potential mechanism. Gekko and Timasheff⁴¹ investigated the effect of glycerol in solution with a variety of proteins showing that glycerol is preferentially excluded from the domain of the protein. The exclusion of glycerol is suggested to stabilize the proteins and favor folded native states. In a similar line of work with PEG, Lee and Lee⁴² investigated the preferential solvent interactions between proteins and polyethylene glycol suggesting an identical mechanism as glycerol; PEGs are excluded from the protein domain with an increase in polymer size causing an increase in exclusion thereby stabilizing the protein. More recent studies by Li et al.⁴³ analyzing sugars and polyols (e.g. glycerol) interactions further shows preferential exclusion from the protein surface thereby stabilizing proteins. The combination of these works and others⁴⁴⁻⁴⁸ suggests that the matrices used may have a similar mechanism in order to protect/preserve the soft-landed proteins of interest with low amounts of PPG, TritonX-100, and diglycerol showing the most extreme protection capabilities of the matrices examined.

It is suspected that by decreasing the distance the protein complexes need to traverse to interact with the grid while increasing the concentration of protein in the matrix allows for increased probability of particle-surface interaction. This approach results in more reproducible distributions and higher densities of particles, thus allowing for the preparation of TEM grids comparable in particle distribution and density to conventionally prepared TEM samples. With the reproducibility and particle density afforded by PPG, it is possible to probe aspects of the mass spectrometer that were difficult to investigate with glycerol previously. This could allow for insight into the effects of desolvation, isolation capabilities, in-source fragmentation, and charge reduction on the structure of protein complexes.

Having now fully described the present invention in some detail by way of illustration and examples for purposes of clarity of understanding, it will be obvious to one of ordinary skill in the art that the same can be performed by modifying or changing the invention within a wide and equivalent range of conditions, formulations and other parameters without affecting the scope of the invention or any specific embodiment thereof, and that such modifications or changes are intended to be encompassed within the scope of the appended claims.

When a group of materials, compositions, components or compounds is disclosed herein, it is understood that all individual members of those groups and all subgroups thereof are disclosed separately. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure. Additionally, the end points in a given range are to be included within the range. In the disclosure and the claims, “and/or” means additionally or alternatively. Moreover, any use of a term in the singular also encompasses plural forms.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements.

One of ordinary skill in the art will appreciate that starting materials, device elements, analytical methods, mixtures and combinations of components other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. The invention illustratively described herein suitably may be practiced in the absence of any element or elements, limitation or limitations which is not specifically disclosed herein. Headings are used herein for convenience only.

All publications referred to herein are incorporated herein to the extent not inconsistent herewith. Some references provided herein are incorporated by reference to provide details of additional uses of the invention. All patents and publications mentioned in the specification are indicative of the levels of skill of those skilled in the art to which the invention pertains. References cited herein are incorporated by reference herein in their entirety to indicate the state of the art as of their filing date and it is intended that this information can be employed herein, if needed, to exclude specific embodiments that are in the prior art.

### REFERENCES

1 Fenn, J. B., Mann, M., Meng, C. K., Wong, S. F. & Whitehouse, C. M. Electrospray Ionization for Mass Spectrometry of Large Biomolecules. Science 246, 64-71, doi: 10.1126/science.2675315 (1989).
2 Tamara, S., Den Boer, M. A. & Heck, A. J. R. High-Resolution Native Mass Spectrometry. Chemical Reviews, doi: 10.1021/acs.chemrev.1c00212 (2021).
3 Hogan, C. J., Ruotolo, B. T., Robinson, C. V. & de la Mora, J. F. Tandem Differential Mobility Analysis-Mass Spectrometry Reveals Partial Gas-Phase Collapse of the GroEL Complex. J. Phys. Chem. B 115, 3614-3621, doi: 10.1021/jp109172k (2011).
4 Lanucara, F., Holman, S. W., Gray, C. J. & Eyers, C. E. The power of ion mobility-mass spectrometry for structural characterization and the study of conformational dynamics. Nat. Chem. 6, 281-294, doi: 10.1038/nchem. 1889 (2014).
5 Covey, T. & Douglas, D. J. Collision Cross-Sections for Protein Ions. Journal of the American Society for Mass Spectrometry 4, 616-623, doi: 10.1016/1044-0305 (93) 85025-s (1993).
6 Ruotolo, B. T. et al. Evidence for macromolecular protein rings in the absence of bulk water. Science 310, 1658-1661, doi: 10.1126/science.1120177 (2005).
7 Benesch, J. L. P. et al. Separating and visualisiing protein assemblies by means of preparative mass spectrometry and microscopy. J. Struct. Biol. 172, 161-168, doi: 10.1016/j.jsb.2010.03.004 (2010).
8 Mikhailov, V. A., Mize, T. H., Benesch, J. L. P. & Robinson, C. V. Mass-Selective Soft-Landing of Protein Assemblies with Controlled Landing Energies. Analytical Chemistry 86, 8321-8328, doi: 10.1021/ac5018327 (2014).
9 Longchamp, J.-N. et al. Imaging proteins at the single-molecule level. Proceedings of the National Academy of Sciences 114, 1474-1479, doi: 10.1073/pnas. 1614519114 (2017).
10 Rose, R. J., Damoc, E., Denisov, E., Makarov, A. & Heck, A. J. R. High-sensitivity Orbitrap mass analysis of intact macromolecular assemblies. Nature Methods 9, 1084-+, doi: 10.1038/nmeth.2208 (2012).
11 Braig, K. et al. The Crystal-Structure of the Bacterial Chaperonin GroEL at 2.8-Angstrom. Nature 371, 578-586, doi: 10.1038/371578a0 (1994).
12 De Carlo, S. & Harris, J. R. Negative staining and cryo-negative staining of macromolecules and viruses for TEM. Micron 42, 117-131, doi: 10.1016/j.micron.2010.06.003 (2011).
13 Harris, J. R. & Horne, R. W. Negative Staining-A Brief Assessment of Current Technical Benefits, Limitations and Future Possibilities. Micron 25, 5-13 (1994).
14 Carpenter, J. F. & Crowe, J. H. The Mechanism of Cryoprotection of Proteins by Solutes. Cryobiology 25, 244-255, doi: 10.1016/0011-2240 (88) 90032-6 (1988).
15 Crowe, J. H., Carpenter, J. F., Crowe, L. M. & Anchordoguy, T. J. Are Freezing and Dehydration Similar Stress Vectors-A Comparison of Modes of Interaction of Stabilizing Solutes with Biomolecules. Cryobiology 27, 219-231, doi: 10.1016/0011-2240 (90) 90023-w (1990).
16 Siuzdak, G. et al. Mass spectrometry and viral analysis. Chem. Biol. 3, 45-48, doi: 10.1016/s1074-5521 (96) 90083-6 (1996).
17 Ouyang, Z. et al. Preparing protein microarrays by soft-landing of mass-selected ions. Science 301, 1351-1354, doi: 10.1126/science. 1088776 (2003).
18 Vonck, J., Parcej, D. N. & Mills, D. J. Structure of Alcohol Oxidase from Pichia pastoris by Cryo-Electron Microscopy. PLOS ONE 11, e0159476, doi: 10.1371/journal.pone.0159476 (2016).
19 Matthews, B. W. The structure of E. coli β-galactosidase. Comptes Rendus Biologies 328, 549-556, doi: 10.1016/j.crvi.2005.03.006 (2005).
20 Johnson, G. E., Hu, Q. C. & Laskin, J. in Annual Review of Analytical Chemistry, Vol 4 Vol. 4 Annual Review of Analytical Chemistry (eds R. G. Cooks & E. S. Yeung) 83-104 (Annual Reviews, 2011).
21 Grant, T., Rohou, A. & Grigorieff, N. cisTEM, user-friendly software for single-particle image processing. eLife 7, doi: 10.7554/elife.35383 (2018).
22 McCabe, J. W. et al. The IMS Paradox: A Perspective on Structural lon Mobility-Mass Spectrometry. Mass Spectrometry Reviews 40, 280-305, doi: 10.1002/mas.21642 (2021).
23 Vanaernum, Z. L. et al. Surface-Induced Dissociation of Noncovalent Protein Complexes in an Extended Mass Range Orbitrap Mass Spectrometer. Analytical Chemistry 91, 3611-3618, doi: 10.1021/acs.analchem.8b05605 (2019).
24 Gault, J. et al. Combining native and ‘omics’ mass spectrometry to identify endogenous ligands bound to membrane proteins. Nature Methods 17, 505-508, doi: 10.1038/s41592-020-0821-0 (2020).
25 Brodbelt, J. S., Morrison, L. J. & Santos, I. Ultraviolet Photodissociation Mass Spectrometry for Analysis of Biological Molecules. Chemical Reviews 120, 3328-3380, doi: 10.1021/acs.chemrev.9b00440 (2020).
26 Naydenova, K., Jia, P. P. & Russo, C. J. Cryo-EM with sub-1 angstrom specimen movement. Science 370, 223-+, doi: 10.1126/science.abb7927 (2020).
27 Roh, S. H. et al. Subunit conformational variation within individual GroEL oligomers resolved by Cryo-EM. Proceedings of the National Academy of Sciences of the United States of America 114, 8259-8264 (2017).
28. Pettersen, E. F. et al. UCSF chimera-A visualization system for exploratory research and analysis. Journal of Computational Chemistry 25, 1605-1612 (2004).
29. Berman, H., Henrick, K. & Nakamura, H. Announcing the worldwide Protein Data Bank. Nature Structural Biology 10, 980-980 (2003).
30. Merk, A. et al. 1.8 angstrom resolution structure of beta-galactosidase with a 200 kV CRYO ARM electron microscope. lucrj 7, 639-643 (2020).
31. Nguyen, Q. T. et al. Structure-based engineering of phanerochaete chrysosporium alcohol oxidase for enhanced oxidative power toward glycerol. Biochemistry 57, 6209-6218 (2018).
32. Takáts, Z., Wiseman, J. M., Gologan, B. & Cooks, R. G. Electrosonic spray ionization. A gentle technique for generating folded proteins and protein complexes in the gas phase and for studying ion-molecule reactions at atmospheric pressure. Analytical Chemistry 76, 4050-4058 (2004).
33. Westphall, M. S. et al. Three-dimensional structure determination of protein complexes using matrix-landing mass spectrometry. Nature Communications 13, 2276 (2022).
34. Vagenende, V., Yap, M. G. S. & Trout, B. L. Mechanisms of protein stabilization and prevention of protein aggregation by glycerol. Biochemistry 48, 11084-11096 (2009).
35. Capelle, M. A. H., Gurny, R. & Arvinte, T. High throughput screening of protein formulation stability: Practical considerations. European Journal of Pharmaceutics and Biopharmaceutics 65 131-148 (2007).
36. Olsson, C., Jansson, H. & Swenson, J. The Role of Trehalose for the Stabilization of Proteins. Journal of Physical Chemistry B 120, 4723-4731 (2016).
37. Mitchell, D. E. et al. Ice-recrystallization inhibiting polymers protect proteins against freeze-stress and enable glycerol-free cryostorage. Materials Horizons 6, 364-368 (2019).
38. García, J. I., Garcia-Marin, H. & Pires, E. Glycerol based solvents: Synthesis, properties and applications. Green Chemistry 16 1007-1033 (2014).
39. Grant, T., Rohou, A. & Grigorieff, N. cisTEM, user-friendly software for single-particle image processing. elife 7, e35383 (2018).
40. Majumder, P. et al. Cryo-EM structures of the archaeal PAN-proteasome reveal an around-the-ring ATPase cycle. Proc Natl Acad Sci USA 116, 534-539 (2019).
41. Gekko, K. and Timasheff, S. N. Mechanism of Protein Stabilization by Glycerol: Preferential Hydration in Glycerol-Water Mixtures. Biochemistry 20 (16), 4667-4676 (1981).
42. James C. Lee and Lucy L. Y. Le, Preferential Solvent Interactions between Proteins and Polyethylene Glycols. Journal of Biological Chemistry 256 (2), 625-631 (1981).
43. Jingwen Li, Jingfei Chen, Liaoyuan An, Xiaoxiang Yuan & Lishan Yao, Polyol and sugar osmolytes can shorten protein hydrogen bonds to modulate function. Communications biology, 3 (1), 1-8 (2020).
44. Michael Senske, Lisa Törk, Benjamin Born, Martina Havenith, Christian Herrmann, and Simon Ebbinghaus, Protein Stabilization by Macromolecular Crowding through Enthalpy Rather Than Entropy. Journal of the American Chemical Society 136 (25), 9036-9041 (2014).
45. Jianqiang Maa, Ileana M. Pazosa, and Feng Gaia, Microscopic insights into the protein-stabilizing effect of trimethylamine N-oxide (TMAO). Proc Natl Acad Sci U S A 111 (23), 8259-8264 (2014).
46. Kim A. Sharp et al., Analysis of the size dependence of macromolecular crowding shows that smaller is better. Proc Natl Acad Sci USA 112 (26), 7990-7995 (2015).
47. Anjeeta Rani and Pannuru Venkatesu, Changing relations between proteins and osmolytes: a choice of nature. Physical Chemistry Chemical Physics 20 (31), 20315-20333 (2018).
48. Marcin Stasiulewicz, Aneta Panuszko, Piotr Bruździak, and Janusz Stangret, Mechanism of Osmolyte Stabilization-Destabilization of Proteins: Experimental Evidence. The Journal of Physical Chemistry B 126 (16), 2990-2999 (2022).

1-40. (canceled)

41. A method for preparing a sample comprising the steps of:
a) contacting a substrate surface with a liquid or semiliquid substance thereby forming a matrix layer of the liquid or semiliquid substance on the substrate surface; and
b) depositing target molecules having an initial structure onto or within the matrix layer under vacuum;
wherein the target molecules are at least partially embedded in the matrix layer and wherein the initial structure of at least a portion of the target molecules is maintained while within the vacuum.

42. The method of claim 41 wherein the target molecules are ions and the method comprises generating the target molecules by ionizing precursor molecules.

43. The method of claim 41 wherein the target molecules comprise peptides, proteins, or ions thereof.

44. The method of claim 43 wherein the peptides, proteins, or ions thereof have a secondary or tertiary structure that is retained while within the vacuum.

45. The method of claim 41 further comprising imaging the target molecules deposited onto or within the matrix layer, wherein the imaging comprises transmission electron microscopy (TEM), scanning electron microscopy (SEM), cryogenic electron microscopy (cryo-EM), X-ray imaging, fluorescent labeling, immunolabeling, and combinations thereof.

46. The method of claim 45 further comprising generating three-dimensional reconstructed images of the target molecules.

47. The method of claim 41 wherein the step of depositing the target molecules is performed at a pressure equal to or less than 10⁻⁴ Torr.

48. The method of claim 41 wherein the step of depositing the target molecules is performed a temperature between −90° C. and 50° C.

49. The method of claim 41 wherein the liquid or semiliquid substance comprise glycerol, water, ethylene glycol, poly(ethylene) glycol (PEG), poly(propylene) glycol (PPG), triethanolamine (TEA), TritonX-100, diglycerol, glycose, sucrose, inositol, glycine, proline, trehalose, and combinations thereof.

50. The method of claim 41 further comprising a staining step comprising contacting exposed areas of the partially embedded target molecules with metal particles or a metal containing solution.

51. The method of claim 41 comprising binding a portion of the partially embedded target molecules to a fluorescent tag, epitope tag or antibody tag.

52. A method for preparing a sample for electron microscopy (EM) comprising the steps of:
a) contacting a substrate surface with a liquid or semiliquid substance thereby forming a matrix layer of the liquid or semiliquid substance on the substrate surface, wherein the substrate is an electron microscopy (EM) grid;
b) generating a first distribution of precursor ions from a sample of target molecules;
c) separating a portion of ions from the first distribution of precursor ions according to mass-to-charge ratios of the precursor ions, thereby generating separated ions;
d) generating an ion beam containing the separated ions, and
e) directing the ion beam to the substrate surface under vacuum;
thereby depositing target molecule ions onto or within the matrix layer, wherein the target molecule ions are partially embedded in the matrix layer and wherein the structure of at least a portion of the target molecule ions is retained.

53. The method of claim 52 wherein the target molecules comprise ions generated from peptides or proteins.

54. The method of claim 52 wherein the step of generating a first distribution of precursor ions and the separating step are performed by a modified mass spectrometer.

55. The method of claim 52 further comprising a staining step comprising contacting exposed areas of the partially embedded target molecules with metal particles or a metal containing solution.

56. A system for depositing target molecules on a substrate comprising:
a) an ion source able to generate ions from a sample of molecules;
b) first ion focusing optics in fluid communication with the ion source;
c) ion separation optics in fluid communication with the first ion focusing optics, wherein the first ion focusing optics are able to transport ions from the ion source to the ion separation optics, and wherein the ion separation optics are able to separate ions according to the mass-to-charge ratios of the ions;
d) a sample chamber in fluid communication with the ion separation optics, wherein the sample chamber maintains a vacuum and contains a substrate able to be inserted into and removed from the sample chamber while maintaining the vacuum; and
e) a controller, operably connected to the first ion focusing optics, the ion separation optics, and the sample chamber, where the controller controls the first ion focusing optics and ion separation optics so as to:
i) transport the ions from the ion source to the ion separation optics;
ii) generate a first distribution of precursor ions from the transported ions;
iii) isolate a target range of mass-to-charge ratios within the first distribution of precursor ions, thereby generating separated ions;
iv) generate an ion beam comprising the separated ions; and
v) contacting the substrate in the sample chamber with the ion beam, thereby depositing separated ions on the substrate under a vacuum.

57. The system of claim 56 further comprising a mass analyzer in fluid communication with the ion separation optics able to detect the separated ions, wherein the controller is able to controller the mass analyzer so as to measure the mass-to-charge ratios of the separated ions and generate mass spectrometry data.

58. The system of claim 56 further comprising second ion focusing optics in fluid communication with the ion separation optics, the mass analyzer, and sample chamber, wherein the second ion focusing optics are under operational control of the controller so as to be able to transport the separated ions from the ion separation optics to the mass analyzer and/or the sample chamber.

59. The system of claim 56 wherein the substrate comprises a matrix layer of a liquid or semiliquid substance deposited on a surface of the substrate.

60. The system of claim 56 wherein the sample chamber has an interior pressure equal to or less than 10⁻⁴ Torr and the sample chamber has an interior temperature between −90° C. and 50° C.
